(19) United States
(12) Patent Application Publication
(10) Pub. No.: US 2026/0241694 A1
(43) Pub. Date: Aug. 20, 2026

(54) LIQUID DISCHARGE HEAD AND LIQUID DISCHARGE APPARATUS

(71) Applicant: CANON KABUSHIKI KAISHA, Tokyo (JP)

(72) Inventors: YUJI TAMARU, Tokyo (JP); CHIAKI MURAOKA, Saitama (JP); YOSUKE TAKAGI, Kanagawa (JP); KOICHI KUBO, Kanagawa (JP); KAZUYA YOSHII, Kanagawa (JP)

(21) Appl. No.: 19/539,245

(22) Filed: Feb. 13, 2026

(30) Foreign Application Priority Data
Feb. 17, 2025 (JP) 2025-023460

(51) Int. Cl. B41J 2/175; B41J 2/14; B41J 2/19

(52) U.S. Cl. CPC B41J 2/175; B41J 2/14; B41J 2/1404; B41J 2/14233; B41J 2/19; B41J 2002/14241

(57) ABSTRACT

A liquid discharge head includes a circulation channel capable of having liquid be circulate, a discharge unit configured to discharge liquid circulating through the circulation channel, a circulation pump configured to have liquid circulate through the circulation channel, a pump drive unit configured to drive the circulation pump in accordance with ability information being able to be set by a component of the circulation pump, a head board configured to implement a function of the pump driver unit, and a storage unit configured to be mounted on the head board and configured to store the ability information. The ability information is an indicator of ability to have liquid circulate through the circulation channel.

### BACKGROUND

### Field of the Technology

The present disclosure relates to control of the circulation flow rate of ink.

### Description of the Related Art

In the field of inkjet printers in recent years, there has been a demand for ink circulation type liquid discharge apparatuses. In addition, Japanese Patent Laid-Open No. 2019-18473 discloses a technique that continues circulation of ink (hereinafter also referred to as liquid) by continuously adjusting the drive voltage of a supply pump and a recovery pump so that the nozzle pressure of an inkjet head becomes a target pressure.

### SUMMARY

A liquid discharge head according to one aspect of the present disclosure includes a circulation channel capable of having liquid be circulate, a discharge unit configured to discharge liquid circulating through the circulation channel, a circulation pump configured to have liquid circulate through the circulation channel, a pump drive unit configured to drive the circulation pump in accordance with ability information being able to be set by a component of the circulation pump, a head board configured to implement a function of the pump driver unit, and a storing unit configured to be mounted on the head board and configured to store the ability information, in which the ability information is an indicator of ability to have liquid circulate through the circulation channel.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective view of a liquid discharge apparatus;

FIG. 1B is a block diagram of a control system of the liquid discharge apparatus in FIG. 1A;

FIG. 2 is a diagram illustrating an example of the hardware configuration of the liquid discharge apparatus in FIG. 1A in a first embodiment;

FIG. 3 is an exploded perspective view of the liquid discharge apparatus in FIG. 1A in the first embodiment;

FIG. 4 is an exterior schematic diagram of an ink circulation unit in FIG. 3 in the first embodiment;

FIG. 5 is a schematic diagram of a circulation channel in the liquid discharge head in FIG. 1A in the first embodiment;

FIG. 6 is a diagram illustrating an example of wiring for a circulation pump in FIG. 5 in the first embodiment;

FIG. 7 is a cross-sectional schematic view of the circulation pump in FIG. 6 in the first embodiment;

FIG. 8 is a diagram illustrating an example of the schematic configuration of a pump driving circuit that drives the circulation pump in FIG. 7 in the first embodiment;

FIG. 9 is a diagram illustrating an example of the circuit configuration of a booster circuit in FIG. 8 in the first embodiment;

FIG. 10 is a diagram illustrating an example of the circuit configuration of an output switching circuit in FIG. 8 in the first embodiment;

FIG. 11 is a timing chart of control signals that control the pump driving circuit in FIG. 8 in the first embodiment;

FIG. 12 is a table illustrating the correspondence relationship between the electrostatic capacity of a piezoelectric element provided in the circulation pump and a pump drive frequency in the first embodiment;

FIG. 13 is a table illustrating the correspondence relationship between the thickness of a vibrating plate provided in the circulation pump and the pump drive frequency in a second embodiment;

FIG. 14 is a table illustrating the correspondence relationship between the thickness of a valve element of a diaphragm unit provided in the circulation pump and the pump drive frequency in a third embodiment;

FIG. 15 is a table illustrating ranks corresponding to each of the electrostatic capacity of the piezoelectric element, the vibrating plate thickness of the vibrating plate, and the diaphragm valve thickness of the valve element that are provided in the circulation pump in a fourth embodiment;

FIG. 16 is a table illustrating the correspondence relationship between the total value of ranks and the pump drive frequency in the fourth embodiment;

FIG. 17 is a table illustrating the correspondence relationship between the electrostatic capacity of the piezoelectric element provided in the circulation pump and the pump drive voltage in a fifth embodiment;

FIG. 18 is a timing chart of control signals that control the pump driving circuit in a sixth embodiment;

FIG. 19 is a table illustrating the correspondence relationship between the electrostatic capacity of the piezoelectric element provided in the circulation pump and a pump drive pulse width in the sixth embodiment;

FIG. 20 is a diagram illustrating an example of the schematic configuration of the pump driving circuit that drives the circulation pump in a seventh embodiment; and

FIG. 21 is a diagram illustrating an example of the schematic configuration of the pump driving circuit that drives the circulation pump in an eighth embodiment.

### DESCRIPTION OF THE EMBODIMENTS

Hereinafter, preferred embodiments of the present invention will be described in detail with reference to the accompanying drawings. It should be noted that the following embodiments do not limit the matters of the present disclosure, and not all combinations of features described in the following embodiments are necessarily essential to the solutions of the present disclosure. It should be noted that the same reference numbers are given to the same components.

### Overview

In the inkjet printer field in recent years, an ink circulation type liquid discharge apparatus has been required that can use a special ink according to a discharge receiving medium for outputting high-quality prints. As such an ink circulation type liquid discharge apparatus, a configuration has been proposed in which a supply path and a recovery path for liquid are provided, and the liquid can be circulated by generating a pressure difference between the supply path and the recovery path. In addition, as one of the configurations by which liquid can be circulated, a liquid circulation apparatus that circulates liquid by the operation of a piezoelectric diaphragm has been disclosed. This liquid circulation apparatus includes a supply pump, a recovery pump, and a pump control unit. The supply pump supplies liquid from a liquid accumulating container to a liquid ejection apparatus by the operation of the piezoelectric diaphragm. The recovery pump recovers the liquid from the liquid ejection apparatus and returns the liquid to the liquid accumulating container by the operation of the piezoelectric diaphragm. The pump control unit controls each of the supply pump and the recovery pump. Specifically, the pump control unit adjusts the voltage or frequency of the drive wave of the supply pump and the recovery pump to control the operation of the piezoelectric diaphragm, thereby performing supplying and recovering of the liquid so that the inkjet nozzle pressure becomes a target pressure. By performing supplying and recovering of the liquid in this manner, the liquid can be circulated.

However, even if the above-described operation is performed, the circulating flow rate of the liquid may not be appropriately controlled. For example, in a liquid discharge head, evaporation of water from a discharge orifice for liquid can cause a phenomenon in which the discharge performance of the liquid discharge head is deteriorated. In order to avoid this phenomenon, a liquid circulation operation is performed that recovers the liquid from which water has evaporated near the discharge orifice and supplies the liquid with less water evaporation. That is, in order to reduce evaporation of water from the liquid near the discharge orifice, it is desirable that the circulation flow rate is at a certain level or more.

On the other hand, due to the temperature difference between the temperature of the liquid in the liquid discharge head and the temperature of the liquid in the liquid accumulating container, a temperature distribution may occur within the liquid discharge head in which the liquid temperature differs between a portion with a high liquid circulation flow rate and a portion with a low liquid circulation flow rate. When such a temperature distribution occurs, since the viscosity of the liquid changes depending on the temperature, unevenness is caused in the concentration of the liquid discharged from the liquid discharge head. Therefore, the temperature distribution inside the liquid discharge head can be a factor for uneven concentration during liquid discharge recording. That is, from the viewpoint of the image quality, in order to avoid the occurrence of a temperature distribution with different temperatures, it is desirable that the circulation flow rate is suppressed to be at a certain level or less.

In addition, the temperature adjustment control of the liquid discharge head is control that consumes power. For example, as the circulation flow rate of the liquid is increased within the liquid discharge head, the keep-warm power required to keep the liquid warm is increased. That is, from the viewpoint of suppressing power consumption, it is desirable that the circulation flow rate of the liquid is suppressed to be at a certain level or less.

From the above, a liquid discharge apparatus capable of appropriately controlling the circulation flow rate of liquid as needed is desired. However, due to manufacturing variations in liquid discharge apparatuses, particularly manufacturing variations in circulation pumps, there have been cases in which the circulation flow rate of liquid is not stable, and the circulation flow rate of the liquid cannot be appropriately controlled as needed.

Therefore, a liquid discharge apparatus in the present disclosure includes a circulation channel, a discharge unit, a circulation pump, a pump driving unit, a head board, and a storing unit. The circulation channel is a channel through which liquid can circulate. The discharge unit discharges the liquid circulating through the circulation channel. The circulation pump circulates the liquid in the circulation channel. The pump driving unit drives the circulation pump based on ability information that can be set by a component of the circulation pump. The head board implements the function of the pump driving unit. The storing unit is mounted to the head board and stores the ability information. The ability information is the indicator of the ability to circulate liquid through the circulation channel. According to such a configuration, even if there are manufacturing variations in the liquid discharge apparatus, particularly in the circulation pump, the circulation pump is driven based on the ability information that can be set by a component of the circulation pump. Therefore, since the circulation flow rate of the liquid is stable, the circulation flow rate of the liquid can be appropriately controlled as needed. For example, it is possible to decrease the circulation flow rate in a case where the circulation flow rate of the liquid is increased, and to increase the circulation flow rate in a case where the circulation flow rate of the liquid is decreased. Therefore, it is possible to appropriately achieve the suppression of power consumption and the reduction of water evaporation as needed to achieve both of these overall. Hereinafter, the details of the present disclosure will be described.

### First Embodiment

### Common Configuration of Each Embodiment

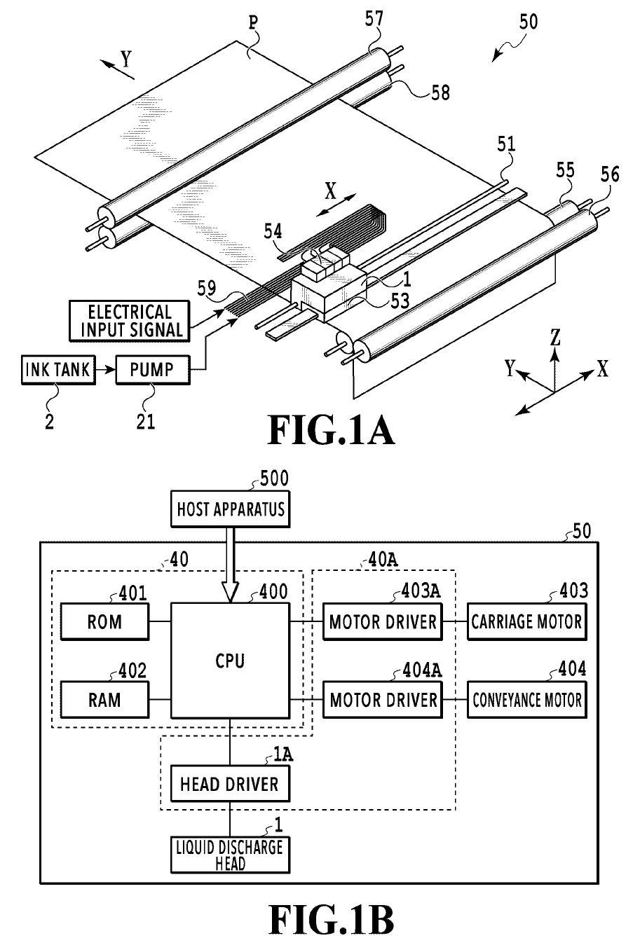

FIG. 1A is a schematic perspective view of the liquid discharge apparatus 50. FIG. 1B is a block diagram of a control system of the liquid discharge apparatus 50 of FIG. 1A. The liquid discharge apparatus 50 includes a liquid discharge head 1 and conveyance rollers 55, 56, 57, and 58. The liquid discharge head 1 is capable of scanning in a direction X that intersects with a conveyance direction Y of a discharge receiving medium P. In an example of FIG. 1A, the liquid discharge head 1 is mounted on a carriage 53. The carriage 53 reciprocates in a main scanning direction (also referred to as the direction X) along a guide shaft 51. The conveyance rollers 55, 56, 57, and 58 convey the discharge receiving medium P in a sub-scanning direction (also referred to as a conveyance direction Y) that intersects (is orthogonal to, in this example) a main scanning direction. That is, the liquid discharge apparatus 50 discharges liquid from the liquid discharge head 1 onto the discharge receiving medium P that is being conveyed in the conveyance direction Y while scanning the liquid discharge head 1 in the direction X, thereby constituting a serial-type inkjet liquid discharge apparatus. It should be noted that application of the present disclosure is not limited to the serial-type inkjet liquid discharge apparatus. The present disclosure can also be applied to a page wide-type inkjet liquid discharge apparatus that discharges liquid to the discharge receiving medium P that is conveyed in the conveyance direction Y, by using a line head (page wide-type head) that is long in a page width direction of the discharge receiving medium P. In FIG. 1A, a direction Z indicates a vertical direction. That is, the direction Z is a direction that intersects with (is orthogonal to, in this example) an XY plane specified by the direction X and the conveyance direction Y. It should be noted that, in the following description, it is assumed that the direction X, the conveyance direction Y, and the direction Z are used in the same sense as described above.

The liquid discharge head 1 can discharge four types of inks, that is, black (K), cyan (C), magenta (M), and yellow (Y). The liquid discharge head 1 can discharge full color images with these four types of inks. It should be noted that the inks that can be discharged from the liquid discharge head 1 is not limited to the above-described four types of ink. For example, the present disclosure can also be applied to the liquid discharge head 1 for discharging other types of inks such as a particular color ink. That is, the types and number of inks discharged from the liquid discharge head 1 are not limited. In addition, a cap member for covering a face surface of the liquid discharge head 1 may be arranged at a position deviated from a conveyance path of the discharge receiving medium P. The cap member relatively moves to the position at which the face surface of the liquid discharge head 1 is covered, in a case where a recording operation is not performed. According to this operation, it is possible to prevent a discharge orifice for the liquid of the liquid discharge head 1 from being dried, or to perform a suctioning operation for filling or recovery.

In the example of FIG. 1A, an ink circulation unit 54 is mounted to the liquid discharge head 1. A guide 59 housing four ink supply tubes (liquid communication path) is attached to the ink circulation unit 54. The guide 59 houses electric wiring lines and air pipes that are required for discharging the liquid, in addition to the ink supply tubes. In addition, an ink tank 2 and a pump 21 are provided on a body (not illustrated) side of the liquid discharge apparatus 50. The ink tank 2 stores the inks. The inks stored in the ink tank 2 is supplied to the ink circulation unit 54 via the four ink supply tubes by the driving force of the pump 21. The liquid discharge head 1 may be provided integrally with the ink circulation unit 54, and may be configured to be detachable from or attachable to the carriage 53. Alternatively, the ink circulation unit 54 may be provided integrally with the carriage 53, and only the ink circulation unit 54 may be configured to be detachable or attachable. It should be noted that, in the following description, an example will be described in which the liquid discharge head 1 includes the ink circulation unit 54.

A CPU 400 in FIG. 1B performs various kinds of control of the liquid discharge apparatus 50. A program such as a processing procedure is stored in a ROM 401. The CPU 400 obtains the program such as the processing procedure from the ROM 401. The CPU 400 controls the liquid discharge apparatus 50 based on the program obtained from the ROM 401. The CPU 400 uses a RAM 402 as a work area for executing the program obtained from the ROM 401. The CPU 400 obtains image data from a host apparatus 500 provided outside the liquid discharge apparatus 50. The CPU 400 controls a head driver 1A based on the image data obtained from the host apparatus 500. The head driver 1A controls discharging of the liquid by the liquid discharge head 1. In addition, the CPU 400 controls a motor driver 403A. The motor driver 403A controls a carriage motor 403. The carriage motor 403 moves the carriage 53 along the direction X. The CPU 400 controls a motor driver 404A. The motor driver 404A controls a conveyance motor 404. The conveyance motor 404 controls the conveyance rollers 55, 56, 57, and 58. The conveyance rollers 55, 56, 57, and 58 convey the discharge receiving medium P along the conveyance direction Y.

### Hardware Configuration

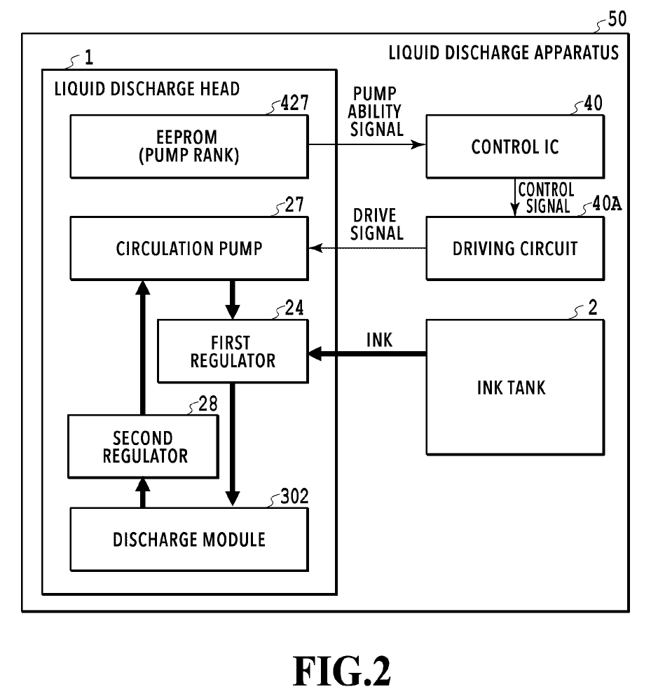

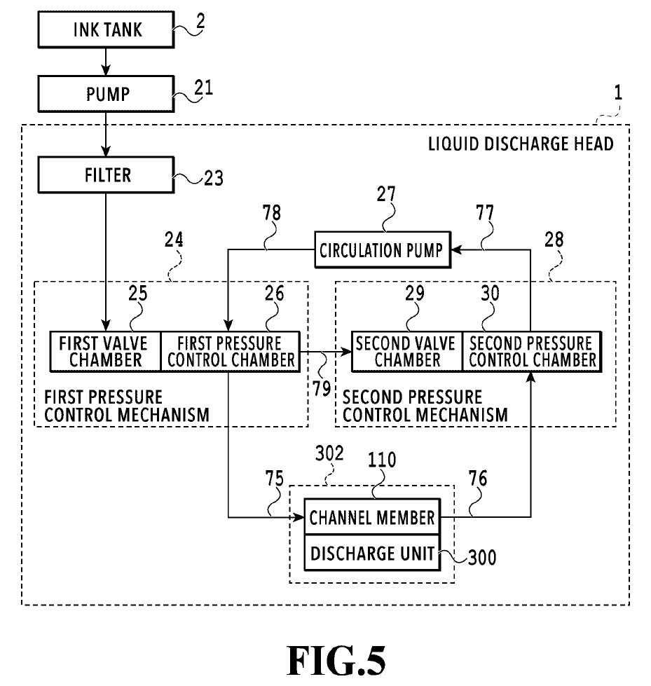

FIG. 2 is a diagram illustrating an example of the hardware configuration of the liquid discharge apparatus 50 in FIG. 1A in a first embodiment. The liquid discharge apparatus 50 includes a control IC 40 and a driving circuit 40A as control elements of the liquid discharge head 1. For example, the CPU 400, the ROM 401, and the RAM 402 in FIG. 1B are included in the control IC 40 in FIG. 2. For example, the head driver 1A, the motor driver 403A, and the motor driver 404A in FIG. 1B are included in the driving circuit 40A in FIG. 2. An EEPROM 427, a circulation pump 27, a first regulator 24, a second regulator 28, and a discharge module 302 are included in the liquid discharge head 1 in FIG. 2. Although the details will be described later, the EEPROM 427 stores ability information. The ability information can be set by a component of the circulation pump 27 as the indicator of the ability to circulate the liquid through the circulation channel. The circulation channel, which will be described later with reference to FIG. 5, is constituted by a channel that passes through the circulation pump 27, the first regulator 24, the discharge module 302, and the second regulator 28. The control IC 40 generates a control signal based on the ability information supplied from the EEPROM 427. The driving circuit 40A generates a drive signal based on the control signal generated by the control IC 40. The circulation pump 27 controls the circulation flow rate of the liquid flowing through the circulation channel based on the drive signal generated by the driving circuit 40A. The liquid that circulates through the circulation channel is supplied from the ink tank 2. That is, the circulation pump 27 controls the circulation flow rate of the ink accumulated in the ink tank 2.

### Liquid Discharge Head 1

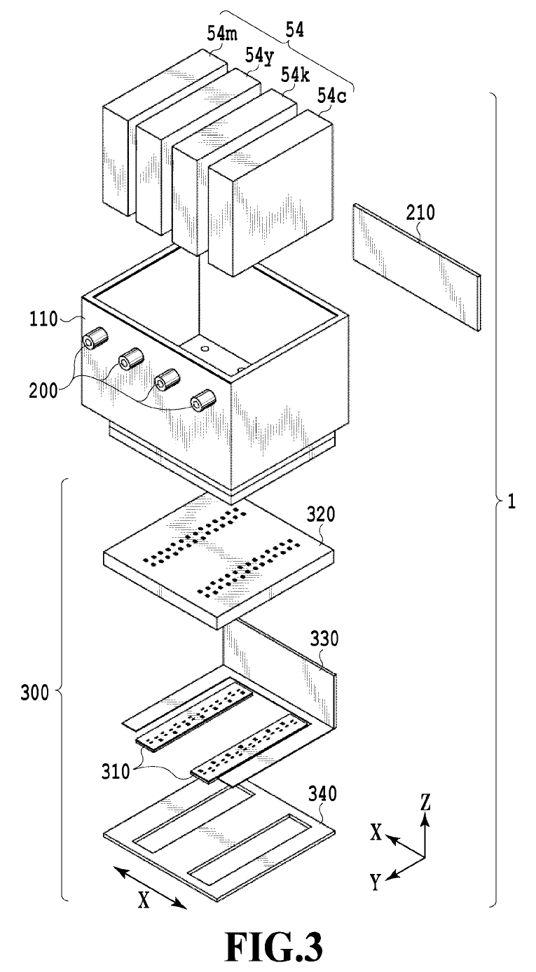

FIG. 3 is an exploded perspective view of the liquid discharge head 1 in FIG. 1 in the first embodiment. The liquid discharge head 1 includes a channel member 110, the ink circulation unit 54, and a discharge unit 300. At least a part of the ink circulation unit 54 is accommodated in the channel member 110, and is connected to the channel member 110. The discharge unit 300 is provided at a bottom portion of the channel member 110, and is connected to the channel member 110. Specifically, the ink circulation unit 54 is constituted by ink circulation units 54m, 54y, 54k, and 54c corresponding to the respective inks. In a case where each of the ink circulation units 54m, 54y, 54k, and 54c is not particularly distinguished from one another, they are referred to as the ink circulation unit 54. Each ink circulation unit 54 is accommodated in and connected to the channel member 110. Each ink circulation unit 54 and the channel member 110 may be connected by screw fastening, after sandwiching a sealing member between each ink circulation unit 54 and the channel member 110. Alternatively, each ink circulation unit 54 and the channel member 110 may be connected by welding. The channel member 110 includes a surface in which four joints 200 connected to the four ink supply tubes corresponding to the four types of inks, respectively, are provided. That is, an individual ink collection channel is provided for each type of ink. Specifically, the ink circulation units 54m, 54y,54k, and 54c are connected to the ink supply tubes corresponding to the inks from the body side of the liquid discharge apparatus 50 via the joints 200, respectively. The inks supplied from the corresponding ink supply tubes are supplied to the ink circulation units 54 via the joints 200, respectively. The inks supplied to the respective ink circulation units 54 are supplied to the discharge unit 300 via the channel member 110.

The discharge unit 300 includes discharge element substrates 310, a support member 320, an electric wiring substrate 330, and a cover member 340. The discharge element substrates 310 and the electric wiring substrate 330 are bonded and fixed to the support member 320. The cover member 340 is adjoined so as to cover a surface of the electric wiring substrate 330. The portions of the cover member 340 corresponding to the discharge element substrates 310 are opened. Each of the discharge element substrates 310 includes an actuator that discharges the inks. Therefore, the discharge element substrates 310 can discharge liquid onto the discharge receiving medium P that passes below the liquid discharge head 1. It should be noted that the discharge unit 300 and the channel member 110 are bonded by using an adhesive agent. Alternatively, the discharge unit 300 and the channel member 110 may be fixed by screw fastening with a sealing member sandwiched between them.

The discharge element substrates 310 and the electric wiring substrate 330 are electrically connected by wire bonding. The electric wiring substrate 330 sends various electric signals to the discharge element substrates 310. Each of the discharge element substrates 310 discharges the liquid by the driving voltage supplied from the head driver 1A in response to the various electric signals from the electric wiring substrate 330. The details of the various electric signals will be described later. It should be noted that the discharge element substrates 310 and the electric wiring substrate 330 may be electrically connected by flying lead bonding or the like.

A contact surface is provided on the side opposite to the surface of the channel members 110 in which the joints 200 are provided. A head board 210 is connected to the contact surface. The head board 210 and the channel member 110 may be fixed by caulking, may be fixed by an adhesive agent, or may be fixed by a two-sided adhesive tape. The head board 210 receives an electric signal from the body of the liquid discharge apparatus 50. The head board 210 and the electric wiring substrate 330 are electrically connected by ACF (Anisotropic conductive film: anisotropic conducting film) pressure bonding. The head board 210 and the electric wiring substrate 330 may be electrically connected by wire bonding. Alternatively, the head board 210 and the electric wiring substrate 330 may be electrically connected by flying lead bonding. The electric signal received by the head board 210 is sent to the discharge element substrate 310 via the electric wiring substrate 330.

It should be noted that the present disclosure also works preferably in a case where the ink circulation unit 54 is provided inside the liquid discharge apparatus and outside the liquid discharge head 1. However, in a mode in which the circulation pump 27 is provided inside the liquid discharge head 1, since the pumping ability is limited due to the size restrictions on the circulation pump 27, the effects of the present disclosure are particularly obtained.

### Circulation Channel

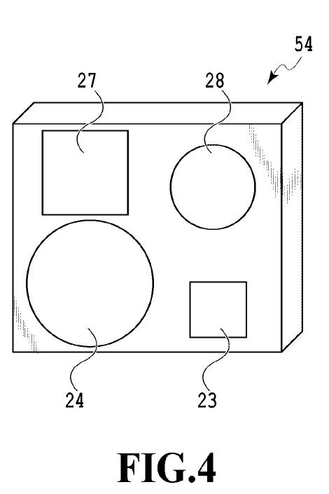

FIG. 4 is an exterior schematic diagram of the ink circulation unit 54 in FIG. 3 in the first embodiment. One ink circulation unit 54 is arranged for one color. The ink circulation unit 54 includes the first regulator 24, the second regulator 28, a filter 23, and the circulation pump 27. FIG. 5 is a schematic diagram of a circulation channel in the liquid discharge head in FIG. 1A in the first embodiment. The circulation channel in FIG. 5 is for one color. In the liquid discharge head 1, the circulation channel in FIG. 5 is provided for each ink. The ink tank 2 and the pump 21 are provided on the body side of the liquid discharge apparatus 50. The first regulator 24 includes a first valve chamber 25 and a first pressure control chamber 26. The first valve chamber 25 and the first pressure control chamber 26 communicate with each other via a valve that is not illustrated. The second regulator 28 includes a second valve chamber 29 and a second pressure control chamber 30. The second valve chamber 29 and the second pressure control chamber 30 communicate with each other via a valve that is not illustrated. The circulation pump 27 and the first pressure control chamber 26 communicate with each other via a pump outlet channel 78. The first pressure control chamber 26 and the channel member 110 communicate with each other via a supply channel 75. A part of the channel member 110 may constitute the supply channel 75. The channel member 110 and the second pressure control chamber 30 communicate with each other via a collecting channel 76. A part of the channel member may constitute the collecting channel 76. The second pressure control chamber 30 and the circulation pump 27 are connected via a pump inlet channel 77. That is, a circulation channel including the first pressure control chamber 26, the supply channel 75, the channel member 110, the collecting channel 76, the second pressure control chamber 30, the pump inlet channel 77, the circulation pump 27, and the pump outlet channel 78 is formed. Ink can circulate through this circulation channel. In addition, the channel member 110 and the discharge unit 300 constitute the discharge module 302. It should be noted that a bypass channel 79 from the first pressure control chamber 26 to the second valve chamber 29 to bypasses an circulation channel is provided between the first pressure control chamber 26 and the second valve chamber 29. The details of the bypass channel 79 will be described later. Next, the details of the circulation pump 27 will be described, and thereafter the flow of ink circulating through the circulation channel will be described.

### Drive Mechanism of Circulation Pump 27

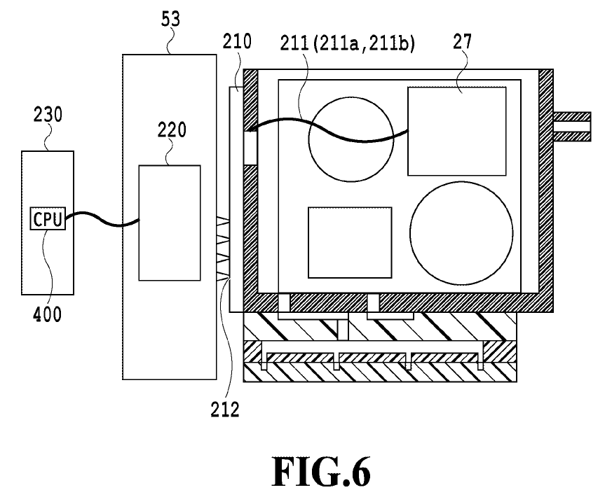

FIG. 6 is a diagram illustrating an example of wiring for the circulation pump 27 in FIG. 5 in the first embodiment. A main PCB 230, a carriage board 220, and a head board 210 are included in the liquid discharge apparatus 50. A main PCB 230 is provided to the body of the liquid discharge apparatus 50. The CPU 400 is mounted to the main PCB 230. The carriage board 220 is provided to the carriage 53. The main PCB 230 and the carriage board 220 are connected via an FFC (flexible flat cable). A drive signal is sent to the carriage board 220 from the CPU 400 via the FFC. The carriage board 220 and the head board 210 are contact-connected via an electric connection portion 212. A pump control signal and a pump drive reference voltage are supplied from the carriage board 220 to the head board 210 via the electric connection portion 212. The head board 210 and the circulation pump 27 are connected via a harness 211. The harness 211 is constituted by a cable assembly including first wiring 211a and second wiring 211b. A pump drive signal 608 generated based on a pump control signal 605 and a pump drive voltage 607 generated from a pump drive reference voltage 604 is supplied to the circulation pump 27 via the harness 211. The circulation pump 27 is driven based on the pump drive signal 608. The liquid in the liquid discharge head 1 is circulated by the driving of the circulation pump 27. The details of the pump control signal 605, the pump drive reference voltage 604, the pump drive voltage 607, and the pump drive signal 608 will be described later. It should be noted that the head board 210 and the carriage board 220 may be electrically connected by being fixed by ACF pressure bonding. Next, the configuration of the circulation pump 27 will be described.

### Internal Configuration of Circulation Pump 27

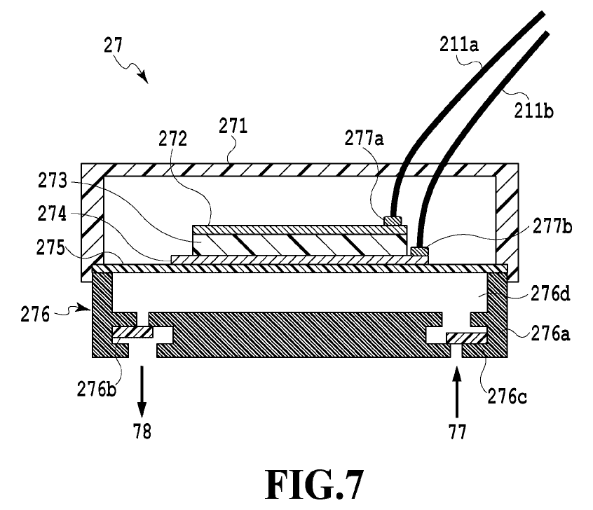

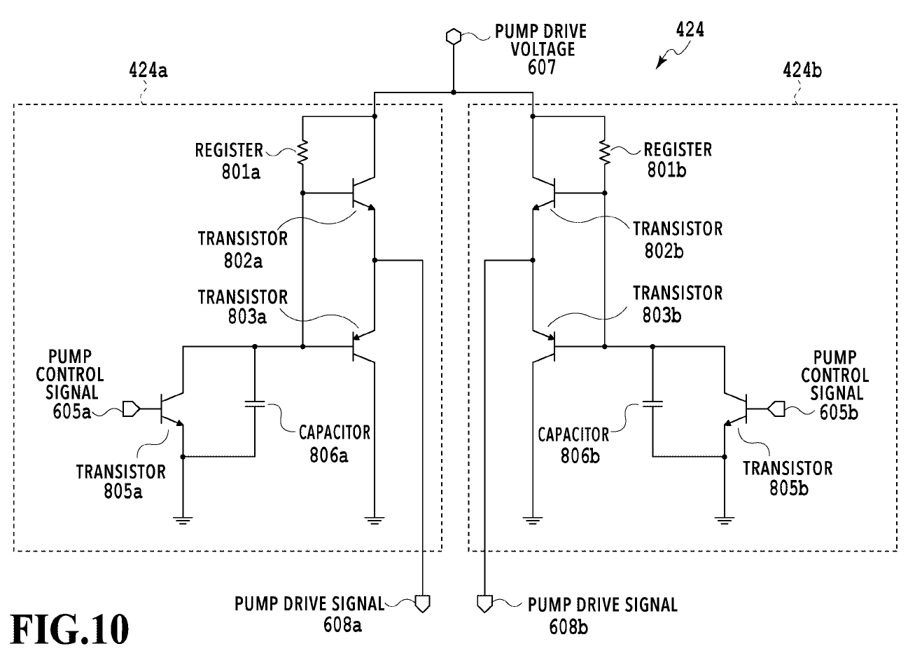

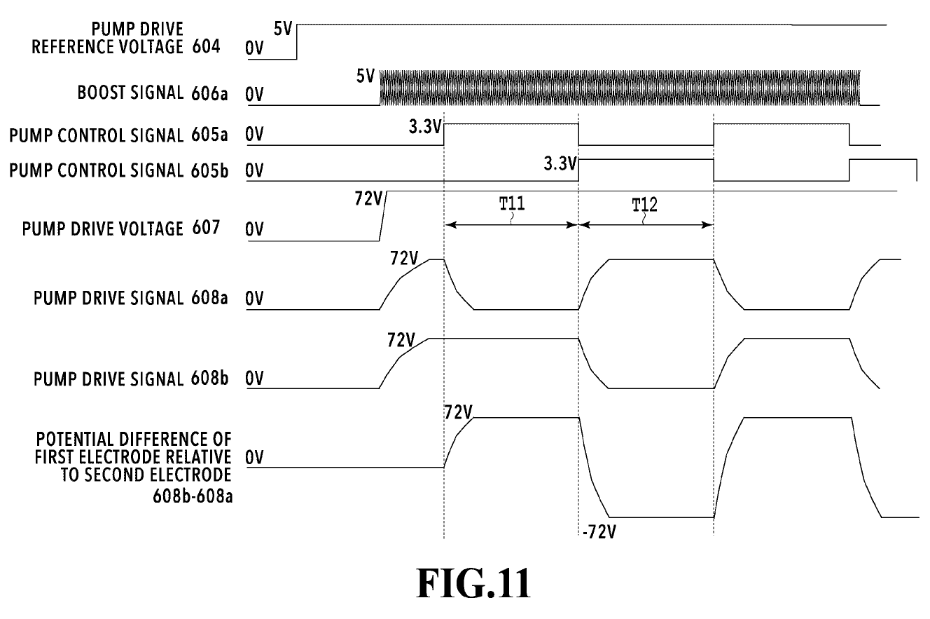

FIG. 7 is a cross-sectional schematic view of the circulation pump 27 in FIG. 6 in the first embodiment. The circulation pump 27 includes a pump housing 271, a diaphragm unit 276, a first electrode 272, a piezoelectric element 273, a second electrode 274, and a vibrating plate 275. The piezoelectric element 273 is provided between the first electrode 272 and the second electrode 274. One surface of the piezoelectric element 273 is in contact with the first electrode 272. The other surface of the piezoelectric element 273 is in contact with the second electrode 274. First wiring 211a is connected to the first electrode 272 via an electric connection member 277a. The first wiring 211a is a signal medium that transmits a pump control signal 605a and a pump drive signal 608a to the circulation pump 27. Second wiring 211b is connected to the second electrode 274 via an electric connection member 277b. The second wiring 211b is a signal medium that transmits a pump control signal 605b and a pump drive signal 608b to the circulation pump 27. The electric connection members 277a and 277b are solder in the present embodiment, but are not particularly limited to this. An electrically conductive member such as a gold bump may be used for the electric connection members 277a and 277b. The details of the pump control signals 605a and 605b and the pump drive signals 608a and 608b will be described later with reference to FIG. 10 and FIG. 11. In addition, one surface of the second electrode 274 is in contact with the piezoelectric element 273, and the other surface is in contact with a vibrating plate 275. That is, a multilayer body in which the first electrode 272, the piezoelectric element 273, the second electrode 274, and the vibrating plate 275 are laminated in this order is constituted. A concave pump housing 271 is provided to cover this multilayer body. In addition, of two surfaces of the vibrating plate 275, the surface opposite to the surface on which the multilayer body is constituted is provided with the diaphragm unit 276. The diaphragm unit 276 includes a diaphragm unit housing 276a, an outflow side valve element 276b, and an inflow side valve element 276c. The diaphragm unit housing 276a is constituted by a concave housing. A concave edge of the diaphragm unit housing 276a and an edge of the vibrating plate 275 are fixed in contact with each other, thereby forming a pressure chamber 276d. That is, the pressure chamber 276d is arranged in close contact with the vibrating plate 275. An inlet port and an outlet port are provided in a bottom portion of the diaphragm unit housing 276a. The outflow side valve element 276b is arranged in the outlet port. The inflow side valve element 276c is arranged in the inlet port. The outflow side valve element 276b functions as a check valve that can move freely according to the outflow of the liquid from the pressure chamber 276d. The inflow side valve element 276c functions as a check valve that can move freely according to the inflow of the liquid into the pressure chamber 276d. The pump outlet channel 78 in FIG. 5 is arranged via the outlet port at the position opposite the outflow side valve element 276b. The pump inlet channel 77 in FIG. 5 is arranged via the inlet port at the position opposite the inflow side valve element 276c. Next, the flow of ink will be described with reference to FIG. 5.

### Flow of Inks

Refer to FIG. 5 again. The pump 21 in FIG. 5 pressurizes and supplies the inks stored in the ink tank 2 to the liquid discharge head 1. The filter 23 removes dust included in the inks pressurized by and supplied from the pump 21. The ink from which dust has been removed by the filter 23 is supplied to the first valve chamber 25. When the inks supplied to the first valve chamber 25 flows into the first pressure control chamber 26, the pressure of the inks is controlled by the circulation pump 27. Next, the details of control of the pressure by the circulation pump 27 will be described with reference to FIG. 7.

A voltage is applied to the piezoelectric element 273 in FIG. 7 to generate a potential difference, the potential difference causes the piezoelectric element 273 to vibrate, and the vibration moves the vibrating plate 275 to change the volume inside the pressure chamber 276d, and generates the pressure fluctuation inside the pressure chamber 276d. Since the pressure fluctuation inside the pressure chamber 276d causes the outflow side valve element 276b and the inflow side valve element 276c to move alternately to send the ink, the circulation pump 27 functions as a piezoelectric diaphragm pump. The circulation pump 27 is driven so as to send the inks with the pump inlet channel 77 being the downstream side and the pump outlet channel 78 being the upstream side. Here, refer to FIG. 5 again. The inks the pressure of which has been controlled inside the first pressure control chamber 26 is supplied to the supply channel 75 and a bypass channel 79 by the driving of the circulation pump 27 in FIG. 5. The supply channel 75 supplies the inks to the channel member 110. The channel member 110 supplies the inks supplied from the supply channel 75 to the discharge unit 300. The inks supplied to the discharge unit 300 is supplied to the discharge element substrates 310 inside the discharge unit 300. Each of the discharge element substrates 310 is provided with a discharge element. The inks supplied to the discharge element substrates 310 pass through the discharge elements and are then discharged to the collecting channel 76. The discharge element includes an energy generating element, a pressure chamber, and a discharge orifice. The inks that have passed through the pressure chamber inside the discharge element and have been discharged to the collecting channel 76 is supplied to the second pressure control chamber 30. In addition, the inks supplied to the second valve chamber 29 via the bypass channel 79 are supplied to the second pressure control chamber 30 that communicates with the second valve chamber 29 via the valve that connects the second valve chamber 29 and the second pressure control chamber 30. Therefore, the inks are supplied to the second pressure control chamber 30 from each of the collecting channel 76 and the bypass channel 79. The inks supplied to the second pressure control chamber 30 are supplied to the circulation pump 27 via the pump inlet channel 77. The inks supplied to the circulation pump 27 are supplied to the first pressure control chamber 26 via the pump outlet channel 78. As described above, the inks pass through the discharge elements formed in the discharge element substrates 310 and are circulated by the circulation pump 27. That is, according to the configuration of the circulation channel, thickening of the inks in the vicinity of the discharge elements can be suppressed. The circulation channel is not limited to the configuration that passes through the discharge elements. For example, as long as it is within a range that has the effect of suppressing thickening of the inks in the vicinity of the discharge elements, the circulation channel may be configured so as to circulate the inks inside the discharge unit 300.

It should be noted that the discharge unit 300 is provided with a temperature sensor and a heater that are not illustrated. The CPU 400 drives the heater as needed, while monitoring the output value of the temperature sensor provided to the discharge unit 300. According to this operation, the temperature of the discharge unit 300 can be maintained in a preferable state for discharging liquid. In addition, although the present disclosure works preferably even without the temperature sensor and the heater, in a case where the temperature sensor and the heater are provided, the power required for keeping the inks warm by the heater is increased as the ink circulation flow rate is increased. Therefore, the effects of the present disclosure can be particularly achieved. Next, regarding the inflow and outflow of the inks, the following first to third use cases will be described with reference to FIG. 7.

### First Use Case

A first use case in which the inks flow into the pressure chamber 276d will be described. A case is assumed where a potential difference occurs in the direction from the second electrode 274 to the first electrode 272, and the piezoelectric element 273 and the vibrating plate 275 are displaced in a direction that expands the pressure chamber 276d. In the case of this assumption, the inflow side valve element 276c is opened, and inks flow into the pressure chamber 276d from the pump inlet channel 77.

### Second Use Case

A second use case in which the inks flow out of the pressure chamber 276d will be described. A case is assumed where a potential difference occurs in the direction from the first electrode 272 to the second electrode 274, and the piezoelectric element 273 and the vibrating plate 275 are displaced in a direction that contracts the pressure chamber 276d. In the case of this assumption, the outflow side valve element 276b is opened, and the inks flow out into the pump outlet channel 78 from the pressure chamber 276d.

### Third Use Case

A description will be given of a third use case in which there is neither inflow of the inks into the pressure chamber 276d nor outflow of the inks from the pressure chamber 276d. A case is assumed where no potential difference occurs between the first electrode 272 and the second electrode 274. In the case of this assumption, the piezoelectric element 273 and the vibrating plate 275 are not displaced in either the direction that expands the pressure chamber 276d or the direction that contracts the pressure chamber 276d. Therefore, the inflow of the inks into the diaphragm unit 276 and the outflow of the inks from the diaphragm unit 276 do not occur.

That is, by periodically changing the potential difference between the first electrode 272 and the second electrode 274, the circulation pump 27 causes the inks to flow from the pump inlet channel 77, and causes the inks to flow out from the pump outlet channel 78. In the circulation pump 27 as described above, manufacturing variations in the vibrating plate 275, the piezoelectric element 273, and the diaphragm unit 276 may affect the liquid delivery ability of the circulation pump 27. Specifically, the thickness of the vibrating plate 275 may affect the displacement of the pressure chamber 276d. Therefore, manufacturing variations in the vibrating plate 275 may affect the liquid delivery ability of the circulation pump 27. In addition, the electrostatic capacity of the piezoelectric element 273 may affect the displacement speed of the piezoelectric element 273 in a case where a certain potential difference is applied between the first electrode 272 and the second electrode 274. Therefore, manufacturing variations in the piezoelectric element 273 may affect the liquid delivery ability of the circulation pump 27. In addition, the ease with which the outflow side valve element 276b and the inflow side valve element 276c of the diaphragm unit 276 can be opened and closed may affect the ease with which the liquid flows into and out of the pressure chamber 276d. Therefore, manufacturing variations in the diaphragm unit 276 may affect the liquid delivery ability of the circulation pump 27. Next, a description will be given of a step of generating the drive signal for driving the circulation pump 27 based on the control signal and the reference voltage.

### Pump Driving Circuit

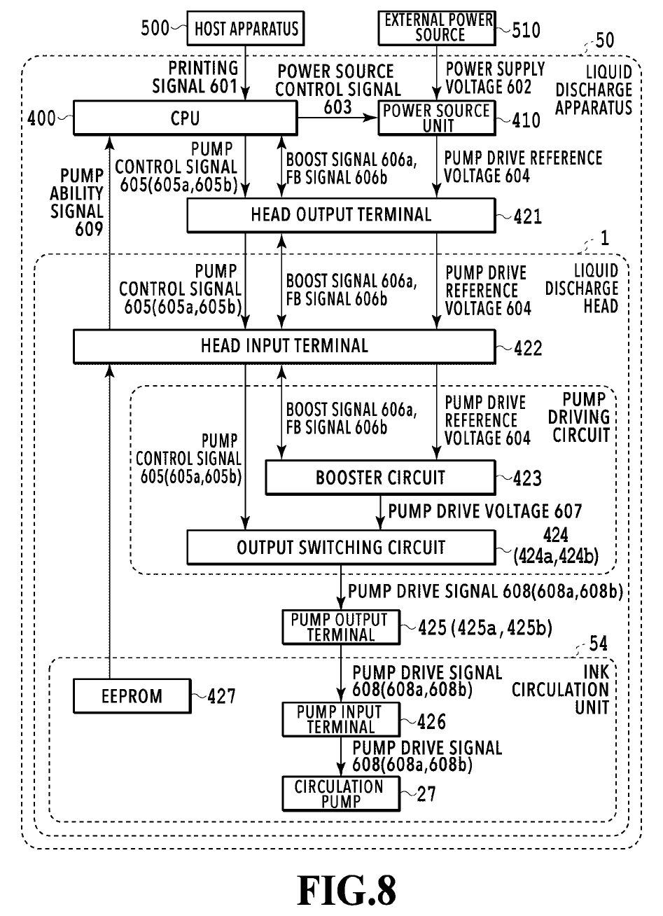

FIG. 8 is a diagram illustrating an example of the schematic configuration of a pump driving circuit that drives the circulation pump 27 in FIG. 7 in the first embodiment. The CPU 400, a power source unit 410, and a head output terminal 421 are included in the body side of the liquid discharge apparatus 50. The liquid discharge head 1 includes a head input terminal 422, a booster circuit 423, an output switching circuit 424, a pump output terminal 425, and an EEPROM 427, in addition to the ink circulation unit 54. The head output terminal 421 supplies various signals and various voltages to the head input terminal 422. The various signals include the pump control signal 605, a boost signal 606a, and the like. The various voltages include the pump drive reference voltage 604. The details of each of the pump control signal 605, the boost signal 606a, and the pump drive reference voltage 604 will be described later. In addition, the head input terminal 422 supplies a feedback signal to the head output terminal 421. Hereinafter, the feedback signal will also be referred to as the FB signal. In addition, among the head input terminal 422, the booster circuit 423, the output switching circuit 424, the pump output terminal 425, and the EEPROM 427, the booster circuit 423 and the output switching circuit 424 function as the pump driving circuit.

A printing signal 601 as image data is input to the CPU 400 included in the body side of the liquid discharge apparatus 50 from the host apparatus 500. On the other hand, a power supply voltage 602 is supplied from an external power source 510 to the power source unit 410 included in the body side of the liquid discharge apparatus 50. The CPU 400 receives the printing signal 601 from the host apparatus 500, thereby activating a power source control signal 603 to the power source unit 410. It should be noted that, in the present embodiment, the power source control signal 603 is assumed to be high active. That is, it is assumed that when the power source control signal 603 is high, the power source unit 410 is set to operate. Specifically, in a case where the signal potential of the power source control signal 603 transitions from 0 V to 3.3 V, the power source unit 410 outputs a pump drive reference voltage 604 to the head output terminal 421. In the present embodiment, the pump drive reference voltage 604 is assumed to be 5 V. The CPU 400 receives the printing signal 601 from the host apparatus 500, thereby outputting a pump control signal 605 and a boost signal 606a to the head output terminal 421.

### Pump Control Signal 605

The pump control signal 605 includes a pump control signal 605a and a pump control signal 605b. The pump control signal 605a and the pump control signal 605b correspond to the first electrode 272 and the second electrode 274, respectively. The pump control signals 605a and 605b are sent to the output switching circuit 424 via the head output terminal 421 and the head input terminal 422. In a case where the signal potential of each of the pump control signals 605a and 605b transitions from 0 V to 3.3 V, each of the pump control signals 605a and 605b becomes active. That is, it is assumed that each of the pump control signals 605a and 605b is high active.

### Boost Signal 606

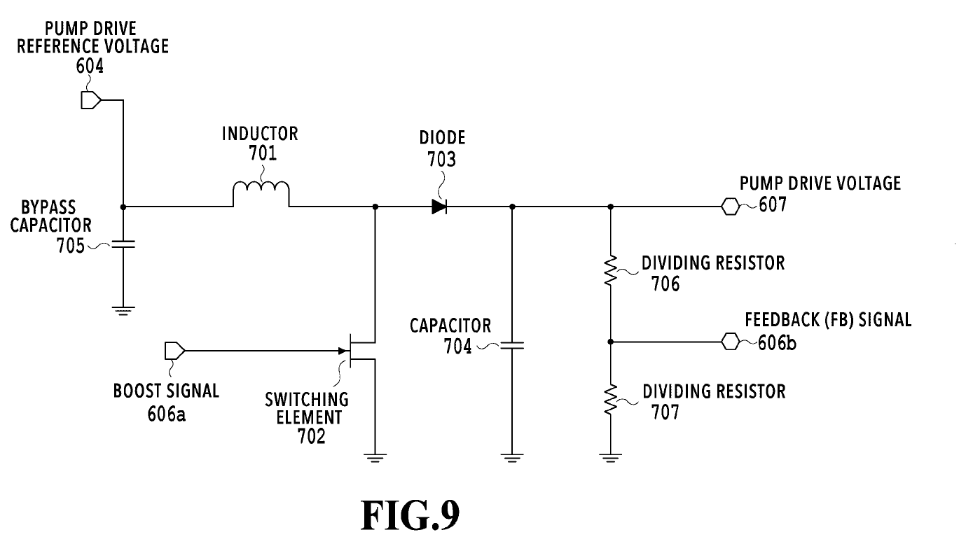

In a case where the signal potential of the boost signal 606 transitions from 0 V to 5 V, which is the active potential, the booster circuit 423 is driven. Specifically, the head output terminal 421 supplies, to the head input terminal 422, the pump control signal 605, the boost signal 606a, and the pump drive reference voltage 604. The head input terminal 422 supplies, to a voltage input terminal of the booster circuit 423, the pump drive reference voltage 604 supplied from the head output terminal 421. The head input terminal 422 supplies, to a signal input terminal of the booster circuit 423, the boost signal 606a supplied from the head output terminal 421. According to the boost signal 606a, the booster circuit 423 converts the pump drive reference voltage 604 of 5 V to a predetermined voltage required for the piezoelectric element 273 provided to the circulation pump 27 to be sufficiently displaced. The booster circuit 423 converts, for example, the pump drive reference voltage 604 of 5 V to a voltage of 72 V. That is, in the present embodiment, it is assumed that the set center voltage for boosting is 72 V. The booster circuit 423 outputs the voltage converted to 72 V to the output switching circuit 424 as a pump drive voltage 607. A specific circuit example of the booster circuit 423 will be described with reference to FIG. 9.

### Booster Circuit 423

FIG. 9 is a diagram illustrating an example of the circuit configuration of the booster circuit 423 in FIG. 8 in the first embodiment. In an example of FIG. 9, the booster circuit 423 includes a bypass capacitor 705, an inductor 701, a switching element 702, a diode 703, a capacitor 704, a dividing resistor 706, and a dividing resistor 707. For example, a chip inductor is used for the inductor 701. For example, an n-channel FET is used for the switching element 702. In FIG. 9, the ground constitutes the potential that serves as the reference for circuit operation. The ground is constituted by, for example, the ground terminal as a frame ground or a signal ground. Alternatively, the ground may be constituted by the ground terminal as a frame earth or a signal earth.

### Connection Configuration of Booster Circuit 423

One terminal of the bypass capacitor 705 is connected to the ground terminal. The other terminal of the bypass capacitor 705 is connected to the voltage input terminal of the booster circuit 423. The pump drive reference voltage 604 is applied to the voltage input terminal of the booster circuit 423. In addition, one terminal of the inductor 701 is also connected to the input terminal of the booster circuit 423. The other terminal of the inductor 701 is connected to an anode of the diode 703, and a drain of the switching element 702. A source of the switching element 702 is connected to the ground terminal. In a case where the boost signal 606a input from the signal input terminal of the booster circuit 423 is input to a gate of the switching element 702, the drain and the source of the switching element 702 are brought into a conductive state. One terminal of the capacitor 704 is connected to a cathode of the diode 703. The other terminal of the capacitor 704 is connected to the ground terminal. In addition, one terminal of the dividing resistor 706 and a first voltage output terminal of the booster circuit 423 are connected to the cathode of the diode 703. The first voltage output terminal of the booster circuit 423 can output the pump drive voltage 607. One terminal of the dividing resistor 707 is connected to the other terminal of the dividing resistor 706. The other terminal of the dividing resistor 707 is connected to the ground terminal. A second voltage output terminal of the booster circuit 423 is connected to a connection point between the dividing resistor 706 and the dividing resistor 707. The second voltage output terminal of the booster circuit 423 can output a feedback signal 606b. It should be noted that the feedback signal 606b is also referred to as the FB signal as needed.

### OPERATION OF BOOSTER CIRCUIT 423

When the potential of the boost signal 606a transitions from the ground potential to the state of 5 V, which is the active potential, the switching element 702 is in a conductive state. Therefore, in a state where the pump drive reference voltage 604 is applied to the voltage input terminal of the booster circuit 423, a current flows to the ground terminal via the inductor 701 and the switching element 702 from the voltage input terminal of the booster circuit 423. Here, in a case where the potential of the boost signal 606a transitions from the active potential to the ground potential, the switching element 702 is in a non-conductive state, and a back electromotive force is generated in the inductor 701. Therefore, the current generated by the back electromotive force of the inductor 701 flows to the capacitor 704 via the diode 703. Accordingly, charge flows into the capacitor 704. The charge that has flowed into and has been accumulated in the capacitor 704 cannot return to the anode side of the diode 703 due to the diode 703. Accordingly, since the conductive state and the non-conductive state of the switching element 702 are repeated by the boost signal 606a, charge flows into and is accumulated in the capacitor 704. As a result, the pump drive voltage 607 is boosted to a voltage higher than the pump drive reference voltage 604. In the present embodiment, the pump drive voltage 607 is divided by the resistance ratio of the dividing resistor 706 and the dividing resistor 707 connected in series, and is linearly stepped down. The voltage linearly stepped down by this voltage division is output from the second voltage output terminal as the FB signal 606b. The FB signal 606b is output to the CPU 400. Based on the FB signal 606b, the CPU 400 controls the ON/OFF duty ratio of the boost signal 606a so that the potential of the pump drive voltage 607 output from the first voltage output terminal becomes 72 V. It should be noted that the booster circuit 423 is not limited to the example in FIG. 9. For example, the booster circuit 423 may be constituted by a charge pump circuit. Alternatively, the booster circuit 423 may be constituted by a power supply unit that converts an alternating current input from the outside to a direct current of 72 V.

### Output Switching Circuit 424

Refer to FIG. 8 again. The output switching circuit 424 outputs the pump drive voltage 607 to the pump output terminal 425 as a pump drive signal 608, according to the pump control signal 605 input from the head input terminal 422. The pump drive signal 608 includes a pump drive signal 608a and a pump drive signal 608b. The details of the output switching circuit 424 will be described with reference to FIG. 10.

FIG. 10 is a diagram illustrating an example of the circuit configuration of the output switching circuit 424 in FIG. 8 in the first embodiment. The output switching circuit 424 includes a first voltage control circuit 424a and a second voltage control circuit 424b. The first voltage control circuit 424a and the second voltage control circuit 424b are provided in parallel. In a state where the pump drive voltage 607 is input, the first voltage control circuit 424a outputs the pump drive signal 608a based on the input of the pump control signal 605a. The first voltage control circuit 424a includes an a signal system corresponding to the first electrode 272. The a signal system controls the output of the pump drive signal 608a to the first electrode 272 via the first wiring 211a. Therefore, the a signal system can control the voltage applied to the first electrode 272. In a state where the pump drive voltage 607 is input, the second voltage control circuit 424b outputs the pump drive signal 608b based on the input of the pump control signal 605b. The second voltage control circuit 424b includes a b signal system corresponding to the second electrode 274. The b signal system controls the output of the pump drive signal 608b to the second electrode 274 via the second wiring 211b. Therefore, the b signal system can control the voltage applied to the second electrode 274.

### Connection Configuration of First Voltage Control Circuit424a

The first voltage control circuit 424a includes a register 801a, a transistor 802a, a transistor 803a, a transistor 805a, and a capacitor 806a. The transistor 802a is constituted by an NPN transistor. The transistor 803a is constituted by a PNP transistor. The transistor 805a is constituted by an NPN transistor. One terminal of the register 801a is connected to the collector of the transistor 802a. The collector of the transistor 802a is connected to a voltage input terminal of the pump drive voltage 607. The other terminal of the register 801a is connected to the base of the transistor 802a. The base of the transistor 803a, one terminal of the capacitor 806a, and the collector of the transistor 805a are connected to the base of the transistor 802a. The emitter of the transistor 803a is connected to the emitter of the transistor 802a. The pump drive signal 608a can be output from a signal output terminal provided between the emitter of the transistor 803a and the emitter of the transistor 802a. The pump control signal 605a is input to the base of the transistor 805a. The emitter of the transistor 805a and the other terminal of the capacitor 806a are connected to the ground terminal. It should be noted that the switching elements of the first voltage control circuit 424a are not limited to the transistors 802a, 803a, and 805a. The switching elements of the first voltage control circuit 424a may be FETs.

### Operation of First Voltage Control Circuit 424a

### Potential of Pump Control Signal 605a: Ground Potential

In a state where the potential of the pump control signal 605a is the ground potential, the emitter and collector of the transistor 805a is in a non-conductive state. Therefore, the transistor 805a is open. In a case where the transistor 805a is open, the pump drive voltage 607 is applied to the base of the transistor 802a and the base of the transistor 803a. At this time, in a case where the potential of the pump drive signal 608a is the ground potential, the potential of the emitter of the transistor 802a becomes the ground potential. Therefore, the potential of the emitter of the transistor 802a becomes lower than the potential of the base of the transistor 802a. Accordingly, a base current flows to the output destination of the pump drive signal 608a from the base of the transistor 802a. Therefore, the transistor 802a becomes active, and a voltage having the same potential as the pump drive voltage 607 is output as the pump drive signal 608a. In this case, the output voltage is 72 V. On the other hand, the potential of the emitter of the transistor 803a and the potential of the base of the transistor 803a become the same potential. Therefore, the transistor 803a is open. From the above, in a state where the potential of the pump control signal 605a is the ground potential, the potential of the pump drive signal 608a becomes the potential of the pump drive voltage 607.

### Potential of Pump Control Signal 605a: Active Potential

In a state where the potential of the pump control signal 605a is the active potential, a base current flows to the emitter of the transistor 805a from the base of the transistor 805a. Therefore, the transistor 805a becomes active, and the base of the transistor 802a and the base of the transistor 803a are connected to the ground terminal. At this time, in a case where the potential of the pump drive signal 608a is 72 V, a base current flows to the base of the transistor 803a from the emitter of the transistor 803a. Therefore, the transistor 803a becomes active. In a case where the transistor 803a becomes active, the emitter of the transistor 803a and the collector of the transistor 803a are in a conductive state, and the collector of the transistor 803a is connected to the ground terminal. Therefore, there is a ground potential between the emitter of the transistor 802a and the emitter of the transistor 803a. On the other hand, since the potential of the base of the transistor 802a and the potential of the emitter of the transistor 802a become the same potential, the transistor 802a is open. From the above, in a state where the potential of the pump control signal 605a is the active potential, the potential of the pump drive signal 608a becomes the ground potential.

### Connection Configuration of Second Voltage Control Circuit 424b

The second voltage control circuit 424b includes a register 801b, a transistor 802b, a transistor 803b, a transistor 805b, and a capacitor 806b. The transistor 802b is constituted by an NPN transistor. The transistor 803b is constituted by a PNP transistor. The transistor 805b is constituted by an NPN transistor. One terminal of the register 801b is connected to the collector of the transistor 802b. The collector of the transistor 802b is connected to the voltage input terminal of the pump drive voltage 607. The other terminal of the register 801b is connected to the base of the transistor 802b. The base of the transistor 803b, one terminal of the capacitor 806b, and the collector of the transistor 805b are connected to the base of the transistor 802b. The emitter of the transistor 803b is connected to the emitter of the transistor 802b. The pump drive signal 608b can be output from a signal output terminal provided between the emitter of the transistor 803b and the emitter of the transistor 802b. The pump control signal 605b is input to the base of the transistor 805b. The emitter of the transistor 805b and the other terminal of the capacitor 806b are connected to the ground terminal. It should be noted that the switching elements of the second voltage control circuit 424b are not limited to the transistors 802b, 803b, and 805b. The switching elements of the second voltage control circuit 424b may be FETs.

### Operation of Second Voltage Control Circuit 424b

### Potential of Pump Control Signal 605b: Ground Potential

In a state where the potential of the pump control signal 605b is the ground potential, the emitter and collector of the transistor 805b are in a non-conductive state. Therefore, the transistor 805b is open. In a case where the transistor 805b is open, the pump drive voltage 607 is applied to the base of the transistor 802b and the base of the transistor 803b. At this time, in a case where the potential of the pump drive signal 608b is the ground potential, the potential of the emitter of the transistor 802b becomes the ground potential. Therefore, the potential of the emitter of the transistor 802b becomes lower than the potential of the base of the transistor 802b. Accordingly, a base current flows to the output destination of the pump drive signal 608b from the base of the transistor 802b. Therefore, the transistor 802b becomes active, and the pump drive voltage 607 is output as the pump drive signal 608b. In this case, the output voltage is 72 V. On the other hand, the potential of the emitter of the transistor 803b and the potential of the base of the transistor 803b become the same potential. Therefore, the transistor 803b is open. From the above, in a state where the potential of the pump control signal 605b is the ground potential, the potential of the pump drive signal 608b becomes the potential of the pump drive voltage 607.

### Potential of Pump Control Signal 605b: Active Potential

In a state where the potential of the pump control signal 605b is the active potential, a base current flows to the emitter of the transistor 805b from the base of the transistor 805b. Therefore, the transistor 805b becomes active, and the base of the transistor 802b and the base of the transistor 803b are connected to the ground terminal. At this time, when the potential of the pump drive signal 608b is 72 V, a base current flows to the base of the transistor 803b from the emitter of the transistor 803b. Therefore, the transistor 803b becomes active. In a case where the transistor 803b becomes active, the emitter of the transistor 803b and the collector of the transistor 803b are in a conductive state, and the collector of the transistor 803b is connected to the ground terminal. Therefore, the ground terminal is connected between the emitter of the transistor 802b and the emitter of the transistor 803b. Accordingly, the potential of the pump drive signal 608b becomes the ground potential. On the other hand, since the potential of the base of the transistor 802b and the potential of the emitter of the transistor 802b become the same potential, the transistor 802b is open. From the above, in a state where the potential of the pump control signal 605b is the active potential, the potential of the pump drive signal 608b becomes the ground potential.

### Pump Output Terminal 425

Refer to FIG. 8 again. The pump output terminal 425 is constituted by a pump output terminal 425a and a pump output terminal 425b corresponding to the first electrode 272 and the second electrode 274, respectively. The pump output terminal 425 is provided to the head board 210. Of the pump drive signals 608a and 608b, the pump drive signal 608a is output to the pump output terminal 425a. Of the pump drive signals 608a and 608b, the pump drive signal 608b is output to the pump output terminal 425b. The potentials of the pump drive signals 608a and 608b transition between 0 V and 72 V at a pump drive frequency. 72 V is set as the pump drive voltage for the circulation pump 27. The pump drive signals 608a and 608b output from the pump output terminals 425a and 425b, respectively, are input to a pump input terminal 426 provided to the ink circulation unit 54 via the first wiring 211a and the second wiring 211b. It should be noted that in the present embodiment, the center of the set frequency of the pump drive frequency is 20 Hz.

### Ink Circulation Unit 54

The ink circulation unit 54 includes a pump input terminal 426 and the circulation pump 27 as the configurations relevant to the pump drive signals 608a and 608b. The pump drive signals 608a and 608b sent from the pump output terminals 425a and 425b, respectively, are input to the pump input terminal 426. The pump input terminal 426 outputs each of the pump drive signals 608a and 608b to the circulation pump 27. The circulation pump 27 drives according to each of the pump drive signals 608a and 608b output from the pump input terminal 426. Next, the driving of the circulation pump 27 will be described with reference to FIG. 11.

### Driving of Circulation Pump 27

FIG. 11 is a timing chart of the control signal that controls the pump driving circuit of FIG. 8 in the first embodiment. First, the potential of the pump drive reference voltage 604 transitions from 0 V to 5 V. With the transition, the pump drive reference voltage 604 is applied to the booster circuit 423. Next, the potential of the boost signal 606a repeatedly transitions from 0 V to 5 V according to a predetermined rule. For example, the potential of the boost signal 606a repeatedly becomes 0 V and 5 V based on a predetermined duty ratio. Through the repetition, the potential of the pump drive voltage 607 output from the booster circuit 423 is boosted to 72 V from 0 V. The boosted pump drive voltage 607 is applied to the output switching circuit 424. In the output switching circuit 424, with application of the pump drive voltage 607, the potential of each of the pump drive signals 608a and 608b is increased to 72 V, and becomes the same potential as the potential of the pump drive voltage 607.

### Drive Pulse Width T11

Next, the potential of the pump control signal 605a transitions from 0 V to 3.3 V. When the potential of the pump control signal 605a is 3.3 V, the potential of the pump control signal 605b is 0 V. After the potential of the pump control signal 605a transitions to 3.3 V, the potential of the pump control signal 605a is maintained at 3.3 V over a drive pulse width T11. On the other hand, since the potential of the pump control signal 605a transitions to 3.3 V, the potential of the pump drive signal 608a is decreased from 72 V to 0 V. The time period during which 72 V is decreased to 0 V mainly changes based on the ability of the booster circuit 423 and the capacity of the piezoelectric element 273. The higher the ability of the booster circuit 423, the longer the time period during which 72 V is decreased to 0 V. While the potential of the pump drive signal 608a is being decreased, since the potential of the pump control signal 605b is maintained at 0 V, the potential of the pump drive signal 608b is maintained at 72 V. After reaching 0 V, the potential of the pump drive signal 608a remains at 0 V during the drive pulse width T11 during which the pump control signal 605a continues to be maintained at 3.3 V. Therefore, in the drive pulse width T11, there is a period during which the potential difference between the potential of the pump drive signal 608a and the potential of the pump drive signal 608b becomes 72 V. In this period, the potential difference between the second electrode 274 and the first electrode 272 is 72 V. Due to this potential difference, the volume of the piezoelectric element 273 is displaced, and the inks flow into the pressure chamber 276d from the pump inlet channel 77.

### Drive Pulse Width T12

Next, the potential of the pump control signal 605a transitions to 0 V, and simultaneously, the potential of the pump control signal 605b transitions from 0 V to 3.3 V. After the potential of the pump control signal 605b transitions to 3.3 V, the potential of the pump control signal 605b is maintained at 3.3 V during a drive pulse width T12. On the other hand, since the potential of the pump control signal 605b transitions to 3.3 V, the potential of the pump drive signal 608b is decreased from 72 V to 0 V. After reaching 0 V, the potential of the pump drive signal 608b remains at 0 V during the drive pulse width T12 during which the pump control signal 605b continues to be maintained at 3.3 V. Since the potential of the pump control signal 605a is maintained at 0 V while the potential of the pump drive signal 608b is being decreased, the potential of the pump drive signal 608a transitions from 0 V to 72 V. After reaching 72 V, the potential of the pump drive signal 608a is maintained at 72 V while the potential of the pump control signal 605a is maintained at 0 V. Therefore, in the drive pulse width T12, the potential difference between the potential of the pump drive signal 608a and the potential of the pump drive signal 608b becomes -72 V. Due to this potential difference, the volume of the piezoelectric element 273 is displaced, and the inks flow from the pressure chamber 276d to the pump outlet channel 78.

### Conclusion of Timing Chart

After the period of T12 described above has elapsed, the pump control signal 605a transitions to 3.3 V again, which is the active potential, over the drive pulse width T11. That is, control is repeatedly performed with T11 + T12, where the drive pulse width T11 and the drive pulse width T12 form one cycle. In the present embodiment, the center set value of this T11 + T12 is set to 50 ms. In addition, the drive frequency is set to 20 Hz.

Refer to FIG. 8 again. As illustrated in FIG. 8, the ink circulation unit 54 is provided with the EEPROM (Electrically Erasable Programmable Read-Only Memory) 427. Information 609 of the electrostatic capacity of the piezoelectric element 273 of the circulation pump 27 is written in the EEPROM 427.

It should be noted that the timing at which the information 609 of the electrostatic capacity of the piezoelectric element 273 of the circulation pump 27 is written to the EEPROM 427 is not particularly limited. For example, the information 609 of the electrostatic capacity of the piezoelectric element 273 of the circulation pump 27 may be written in a step of assembling the liquid discharge head 1. Alternatively, the information 609 of the electrostatic capacity of the piezoelectric element 273 of the circulation pump 27 may be written in an inspection step before the liquid discharge head 1 is incorporated into the liquid discharge apparatus 50. Alternatively, the information 609 of the electrostatic capacity of the piezoelectric element 273 of the circulation pump 27 may be written in a step of incorporating the liquid discharge head 1 into the liquid discharge apparatus 50. Alternatively, the information 609 of the electrostatic capacity of the piezoelectric element 273 of the circulation pump 27 may be written before mounting the EEPROM 427 to the ink circulation unit 54. The information 609 of the electrostatic capacity of the piezoelectric element 273 of the circulation pump 27 may be obtained by performing time integration on a discharge current value in a case in which the piezoelectric element 273 of the circulation pump 27 is fully charged and thereafter discharged through a resistor. That is, the information 609 of the electrostatic capacity of the piezoelectric element 273 of the circulation pump 27 may be measured with the constant-current discharge method. Alternatively, the information 609 of the electrostatic capacity of the piezoelectric element 273 of the circulation pump 27 may be measured by an LCR meter. The CPU 400 reads out the information 609 of the electrostatic capacity of the piezoelectric element 273 of the circulation pump 27 from the EEPROM 427 via the head input terminal 422. The information 609 of the electrostatic capacity of the piezoelectric element 273 of the circulation pump 27 is utilized as the information about the liquid delivery ability of the circulation pump 27, i.e., the so-called ability information of the circulation pump 27. The ability information of the circulation pump 27 is, although the details of which will be described later, the information that may be set by a component of the circulation pump 27. In addition, the ability information of the circulation pump 27 is the indicator of the ability to circulate liquid. In the present embodiment, an example has been described in which the EEPROM 427 is used as a configuration for storing the information about the liquid delivery ability of the circulation pump 27, but the present embodiment is not limited to this. For example, the configuration for storing the information about the liquid delivery ability of the circulation pump 27 may be an EPROM (Erasable Programmable Read-Only Memory). Alternatively, the configuration for storing the information about the liquid delivery ability of the circulation pump 27 may be a mask ROM (Read-Only Memory).

### Ability Information of Circulation Pump 27: Electrostatic capacity; Pump Drive Frequency

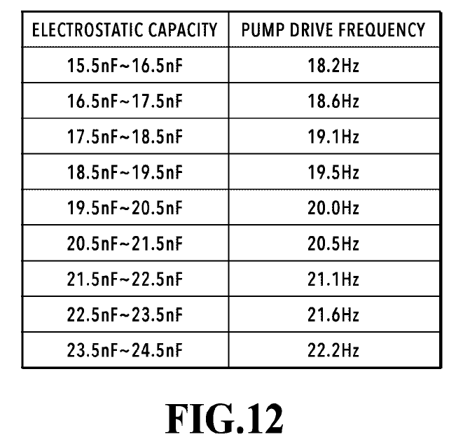

FIG. 12 is a table illustrating the correspondence relationship between the electrostatic capacity of the piezoelectric element 273 provided in the circulation pump 27 and the pump drive frequency in the first embodiment. The electrostatic capacity of the piezoelectric element 273 is a component of the circulation pump 27, and can be the ability information of the circulation pump 27. Therefore, the driving of the circulation pump 27 can be controlled based on the electrostatic capacity of the piezoelectric element 273. In addition, in the present embodiment, it is assumed that not only the information 609 of the electrostatic capacity of the piezoelectric element 273 of the circulation pump 27, but also the contents of the table illustrated in FIG. 12 are written in the EEPROM 427.

Specifically, the CPU 400 refers to the table in FIG. 12 based on the information 609 of the electrostatic capacity of the piezoelectric element 273 read out from the EEPROM 427, and reads out the corresponding pump drive frequency as the pump control signal 605. The timing chart in FIG. 11 corresponds to the case in which the information 609 of the electrostatic capacity of the piezoelectric element 273 is 20 nF. More specifically, as the value of the electrostatic capacity of the piezoelectric element 273 is increased, the displacement speed of the piezoelectric element 273 at the time when the pump drive voltage 607 is applied is decreased. Therefore, it is preferable that as the electrostatic capacity value of the piezoelectric element 273 is increased, the pump drive frequency is set higher than the set center. On the other hand, as the electrostatic capacity value of the piezoelectric element 273 is decreased, the displacement speed of the piezoelectric element 273 at the time when the pump drive voltage 607 is applied is increased. Therefore, it is preferable that as the electrostatic capacity value of the piezoelectric element 273 is decreased, the pump drive frequency is set lower than the set center. In other words, in a case where the electrostatic capacity of the piezoelectric element 273 is a second electrostatic capacity that is larger than a first electrostatic capacity, it is preferable that the CPU 400 increases the drive frequency of the circulation pump 27 to be higher than the drive frequency in the case of the first electrostatic capacity. By performing the processing as described above, even if manufacturing variations occur in the electrostatic capacity of the piezoelectric element 273 of the circulation pump 27, variations in the liquid delivery ability of the circulation pump 27 can be suppressed. That is, the circulation pump 27 can be driven at a circulation flow rate required by the liquid discharge apparatus 50.

### SECOND EMBODIMENT

### Ability Information of Circulation Pump 27: Thickness of Vibrating Plate 275; Pump Drive Frequency

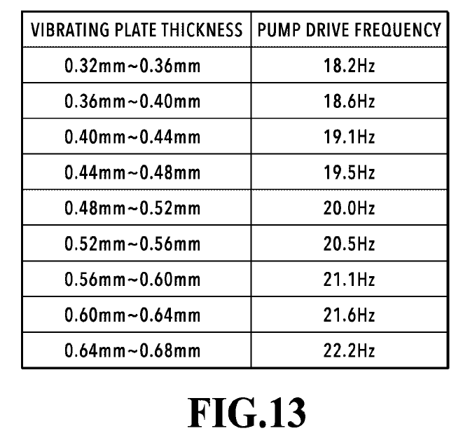

A second embodiment is different from the first embodiment in that the thickness of the vibrating plate 275 is used as the ability information of the circulation pump 27. Hereinafter, the differences from the first embodiment will be mainly described. FIG. 13 is a table illustrating the correspondence relationship between the thickness of the vibrating plate 275 provided in the circulation pump 27 and the pump drive frequency in the second embodiment. The vibrating plate thickness in FIG. 13 is the thickness of the vibrating plate 275. The vibrating plate 275 is a component of the circulation pump 27. The thickness of the vibrating plate 275 can be the ability information of the circulation pump 27. Therefore, the driving of the circulation pump 27 can be controlled based on the thickness of the vibrating plate 275. In addition, in the present embodiment, it is assumed that information 629 of the thickness of the vibrating plate 275 and the contents of the table illustrated in FIG. 13 are written in the EEPROM 427.

It should be noted that the timing at which the information 629 of the thickness of the vibrating plate 275 is written to the EEPROM 427 is not particularly limited. For example, the information 629 of the thickness of the vibrating plate 275 may be written in the step of assembling the liquid discharge head 1. Alternatively, the information 629 of the thickness of the vibrating plate 275 may be written in the inspection step before the liquid discharge head 1 is incorporated into the liquid discharge apparatus 50. Alternatively, the information 629 of the thickness of the vibrating plate 275 may be written in the step of incorporating the liquid discharge head 1 into the liquid discharge apparatus 50. Alternatively, the information 629 of the thickness of the vibrating plate 275 may be written before mounting the EEPROM 427 to the ink circulation unit 54. The information 629 of the thickness of the vibrating plate 275 may be measured by, for example, a laser distance meter during the assembly step.

Specifically, based on the information 629 of the thickness of the vibrating plate 275 read out from the EEPROM 427, the CPU 400 refers to the table in FIG. 13 to read out the corresponding pump drive frequency as the pump control signal 625. More specifically, as the value of the thickness of the vibrating plate 275 is increased, the displacement speed of the piezoelectric element 273 in a case where the pump drive voltage 607 is applied is decreased. Therefore, it is preferable that as the value of the thickness of the vibrating plate 275 is increased, the pump drive frequency is set higher than the set center. On the other hand, as the value of the thickness of the vibrating plate 275 is decreased, the displacement speed of the piezoelectric element 273 in a case where the pump drive voltage 607 is applied is increased. Therefore, it is preferable that as the value of the thickness of the vibrating plate 275 is decreased, the pump drive frequency is set lower than the set center. In other words, in a case where the thickness of the vibrating plate 275 is a second vibrating plate thickness that is larger than a first vibrating plate thickness, it is preferable that the CPU 400 increases the drive frequency of the circulation pump 27 to be higher than the drive frequency in the case of the first vibrating plate thickness. By performing the processing as described above, even if manufacturing variations occur in the thickness of the vibrating plate 275, variations in the liquid delivery ability of the circulation pump 27 can be suppressed. That is, the circulation pump 27 can be driven at a circulation flow rate required by the liquid discharge apparatus 50.

### Third Embodiment

### Ability Information of Circulation Pump 27: Diaphragm Valve Thickness; Pump Drive Frequency

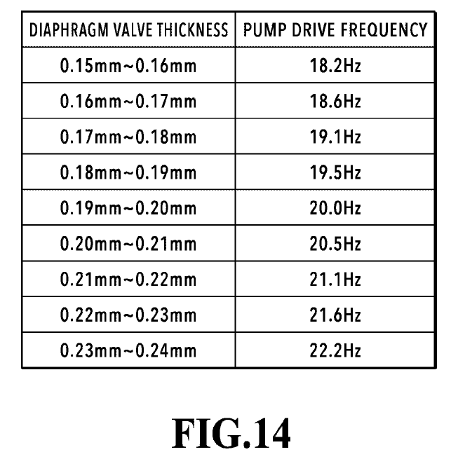

A third embodiment is different from the first and second embodiments in that the outflow side valve element 276b and the inflow side valve element 276c of the diaphragm unit 276, i.e., the diaphragm valve thickness, is used as the ability information of the circulation pump 27. Hereinafter, the differences from the first and second embodiments will be mainly described. FIG. 14 is a table illustrating the correspondence relationship between the thickness of the valve element of the diaphragm unit provided in the circulation pump and the pump drive frequency in the third embodiment. The diaphragm valve thickness in FIG. 14 is the thickness of each of the outflow side valve element 276b and the inflow side valve element 276c. Each of the outflow side valve element 276b and the inflow side valve element 276c is a component of the circulation pump 27. The thickness of each of the outflow side valve element 276b and the inflow side valve element 276c can be the ability information of the circulation pump 27. Therefore, the driving of the circulation pump 27 can be controlled based on the thickness of each of the outflow side valve element 276b and the inflow side valve element 276c. In addition, in the present embodiment, it is assumed that information 639 of the thickness of each of the outflow side valve element 276b and the inflow side valve element 276c and the contents of the table illustrated in FIG. 14 are written in the EEPROM 427.

It should be noted that the timing at which the information 639 of the thickness of each of the outflow side valve element 276b and the inflow side valve element 276c is written to the EEPROM 427 is not particularly limited. For example, the information 639 of the thickness of each of the outflow side valve element 276b and the inflow side valve element 276c may be written in the step of assembling the liquid discharge head 1. Alternatively, the information 639 of the thickness of each of the outflow side valve element 276b and the inflow side valve element 276c may be written in the inspection step before the liquid discharge head 1 is incorporated into the liquid discharge apparatus 50. Alternatively, the information 639 of the thickness of each of the outflow side valve element 276b and the inflow side valve element 276c may be written in the step of incorporating the liquid discharge head 1 into the liquid discharge apparatus 50. Alternatively, the information 639 of the thickness of each of the outflow side valve element 276b and the inflow side valve element 276c may be written before mounting the EEPROM 427 to the ink circulation unit 54. The information 639 of the thickness of each of the outflow side valve element 276b and the inflow side valve element 276c may be measured by, for example, a laser distance meter during the assembly step.

Specifically, based on the information 639 of the thickness of each of the outflow side valve element 276b and the inflow side valve element 276c read out from the EEPROM 427, the CPU 400 refers to the table in FIG. 14 to read out the corresponding pump drive frequency as the pump control signal 635. More specifically, as the value of the thickness of each of the outflow side valve element 276b and the inflow side valve element 276c is increased, the displacement speed of the piezoelectric element 273 at the time when the pump drive voltage 607 is applied is decreased. Therefore, it is preferable that as the value of the thickness of each of the outflow side valve element 276b and the inflow side valve element 276c is increased, the pump drive frequency is set higher than the set center. On the other hand, as the value of the thickness of each of the outflow side valve element 276b and the inflow side valve element 276c is decreased, the displacement speed of the piezoelectric element 273 in a case where the pump drive voltage 607 is applied is increased. Therefore, it is preferable that as the value of the thickness of each of the outflow side valve element 276b and the inflow side valve element 276c is decreased, the pump drive frequency is set lower than the set center. In other words, in a case where the thickness of the inflow side valve element 276c is a second valve thickness that is larger than a first valve thickness, the CPU 400 may increase the drive frequency of the circulation pump 27 to be higher than the drive frequency in the case of the first valve thickness. In addition, in a case where the thickness of the outflow side valve element 276b is the second valve thickness that is larger than the first valve thickness, the CPU 400 may increase the drive frequency of the circulation pump 27 to be higher than the drive frequency in the case of the first valve thickness. By performing the processing as described above, even if manufacturing variations occur in the thickness of each of the outflow side valve element 276b and the inflow side valve element 276c, variations in the liquid delivery ability of the circulation pump 27 can be suppressed. That is, the circulation pump 27 can be driven at a circulation flow rate required by the liquid discharge apparatus 50. It should be noted that FIG. 14 illustrates an example in which the average value of the outflow side valve element 276b and the inflow side valve element 276c is stored in the EEPROM 427, but the example is not particularly limited to this. Each of the outflow side valve element 276b and the inflow side valve element 276c may be individually tabulated. Furthermore, in addition to the outflow side valve element 276b and the inflow side valve element 276c, the information indicating the height of the pressure chamber 276d, or the information indicating the opening area of each of the inlet port and the outlet port may be stored in the EEPROM 427.

### Fourth Embodiment

### Ability Information of Circulation Pump 27: Rank of Component of Circulation Pump 27; Pump Drive Frequency

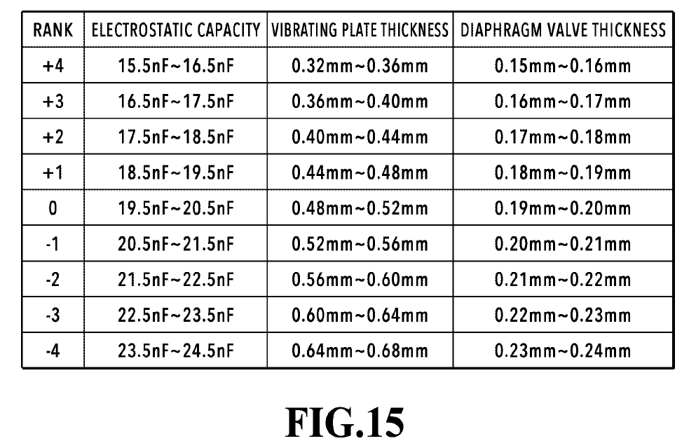

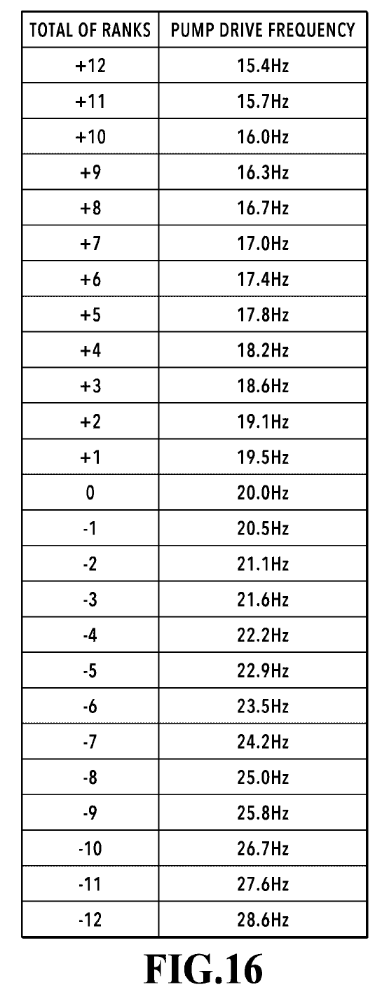

A fourth embodiment is different from the first to third embodiments in that the ranks of components of the circulation pump 27 are used as the ability information of the circulation pump 27. Hereinafter, the differences from the first to third embodiments will be mainly described. FIG. 15 is a table illustrating the ranks corresponding to each of the electrostatic capacity of the piezoelectric element, the vibrating plate thickness of the vibrating plate, and the diaphragm valve thickness of the valve element that are provided in the circulation pump in the fourth embodiment. FIG. 16 is a table illustrating the correspondence relationship between the total value of ranks and the pump drive frequency in the fourth embodiment. As illustrated in FIG. 15, a rank from +4 to -4 is given to each of the electrostatic capacity of the piezoelectric element 273, the thickness of the vibrating plate 275, and the average value of the outflow side valve element 276b and the inflow side valve element 276c. In the present embodiment, it is assumed that the total value of respective ranks of the electrostatic capacity of the piezoelectric element 273, the thickness of the vibrating plate 275, and the average value of the outflow side valve element 276b and the inflow side valve element 276c as well as the contents of the table illustrated in FIG. 16 are written in the EEPROM 427.

Specifically, based on a total value 649 of ranks read out from the EEPROM 427, the CPU 400 refers to the table in FIG. 16 to read out the corresponding pump drive frequency as the pump control signal 645. More specifically, as the total value of ranks is increased to the positive side, the displacement speed of the piezoelectric element 273 in a case where the pump drive voltage 607 is applied is increased. Therefore, as the total value of ranks is increased to the positive side, since the liquid delivery ability of the circulation pump 27 is higher, it is preferable that the pump drive frequency is set lower than the set center. On the other hand, as the total value of ranks is increased to the negative side, the displacement speed of the piezoelectric element 273 in a case where the pump drive voltage 607 is applied is decreased. Therefore, as the total value of ranks is increased to the negative side, since the liquid delivery ability of the circulation pump 27 is lower, it is preferable that the pump drive frequency is set higher than the set center. By performing the processing as described above, even if manufacturing variations occur in the components of the circulation pump 27, variations in the liquid delivery ability of the circulation pump 27 can be suppressed. That is, the circulation pump 27 can be driven at a circulation flow rate required by the liquid discharge apparatus 50. It should be noted that the total value 649 of ranks may be weighted in a predetermined manner. For example, the electrostatic capacity of the piezoelectric element 273 may be weighted.

### Fifth Embodiment

### Ability Information of Circulation Pump 27: Electrostatic Capacity; Pump Drive Voltage

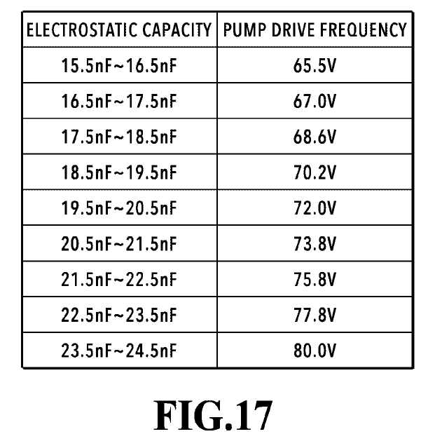

A fifth embodiment is similar to the first embodiment in that the electrostatic capacity of the piezoelectric element 273 is utilized as the ability information of the circulation pump 27, but is different from the first to fourth embodiments in that the pump drive voltage is controlled. Hereinafter, the differences from the first to fourth embodiments will be mainly described. FIG. 17 is a table illustrating the correspondence relationship between the electrostatic capacity of the piezoelectric element provided in the circulation pump 27 and the pump drive voltage in the fifth embodiment. In the present embodiment, it is assumed that not only information 659 of the electrostatic capacity of the piezoelectric element 273 of the circulation pump 27, but also the contents of the table illustrated in FIG. 17 are written in the EEPROM 427.

Specifically, based on the information 659 of the electrostatic capacity of the piezoelectric element 273 read out from the EEPROM 427, the CPU 400 refers to the table in FIG. 17 to output a boost signal 656a so that the corresponding pump drive voltage is achieved. More specifically, as the value of the electrostatic capacity of the piezoelectric element 273 is increased, the displacement speed of the piezoelectric element 273 at the time when the pump drive voltage 607 is applied is decreased. Therefore, it is preferable that as the value of the electrostatic capacity of the piezoelectric element 273 is increased, the boost signal 656a is output so that the pump drive voltage is set higher than the set center. On the other hand, as the value of the electrostatic capacity of the piezoelectric element 273 is decreased, the displacement speed of the piezoelectric element 273 at the time when the pump drive voltage 607 is applied is increased. Therefore, it is preferable that as the value of the electrostatic capacity of the piezoelectric element 273 is decreased, the boost signal 656a is output so that the pump drive voltage is set lower than the set center. By performing the processing as described above, even if manufacturing variations occur in the electrostatic capacity of the piezoelectric element 273 of the circulation pump 27, variations in the liquid delivery ability of the circulation pump 27 can be suppressed. That is, the circulation pump 27 can be driven at a circulation flow rate required by the liquid discharge apparatus 50.

### Sixth Embodiment

### Ability Information of Circulation Pump 27: Electrostatic Capacity; Pump Drive Pulse Width

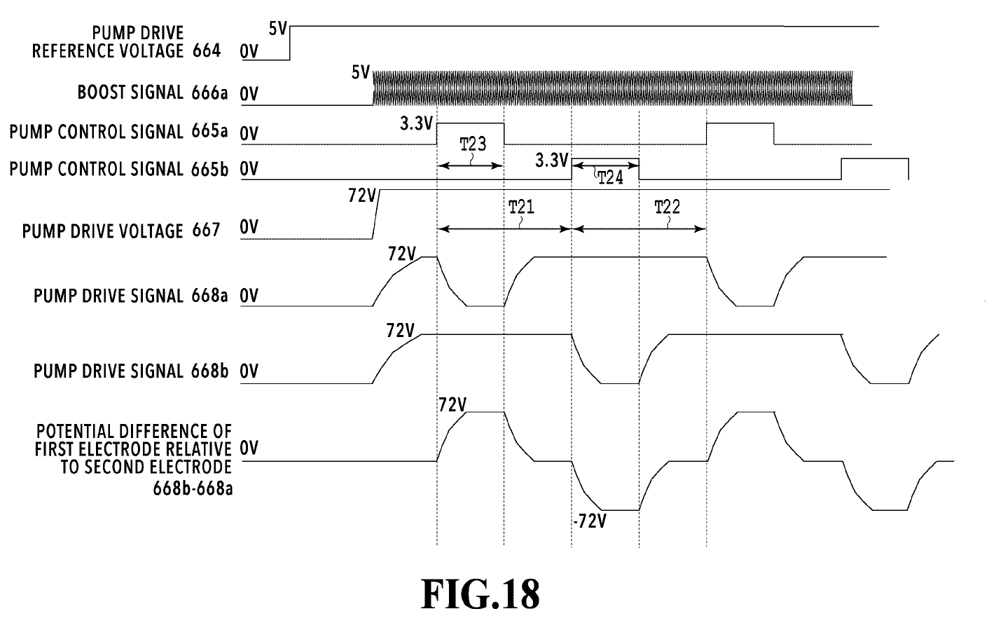

A sixth embodiment is similar to the first embodiment in that the electrostatic capacity of the piezoelectric element 273 is utilized as the ability information of the circulation pump 27, but is different from the first to fifth embodiments in that the pump drive pulse width is controlled. Hereinafter, the differences from the first to fifth embodiments will be mainly described. FIG. 18 is a timing chart of control signals that control the pump driving circuit in the sixth embodiment. The pump drive reference voltage 664 transitions from 0 V to 5 V. Then, according to a predetermined rule, the potential of a boost signal 666a transitions to 0 V and 5 V. With the transition of the potential of the boost signal 666a, a pump drive voltage 667 is boosted from 0 V to 72 V. Then, the potential of a pump control signal 665a transitions from 0 V to 3.3 V. The potential of a pump control signal 665b maintains 0 V. The potential of the pump control signal 665a maintains 3.3 V over a predetermined drive pulse width T23. The potential of a pump drive signal 668a transitions from 72 V to 0 V. In a state where the potential of the pump control signal 665a is 3.3 V, and the potential of the pump drive signal 668a transitions from 72 V to 0 V, the potential of the pump control signal 665b is 0 V. Therefore, the potential of the pump drive signal 668b is 72 V. In the drive pulse width T23, the potential difference between the potential of the pump drive signal 668b and the potential of the pump drive signal 668a, i.e., the potential difference between the potential of the second electrode 274 and the potential of the first electrode 272 of the circulation pump 27, becomes 72 V. Next, the potential of the pump control signal 665a transitions to 0 V. After a predetermined time period T21 has elapsed since the potential of the pump control signal 665a transitions from 0 V to 3.3 V, the potential of the pump control signal 665b transitions from 0 V to 3.3 V, and the potential of the pump control signal 665b maintains 3.3 V over a predetermined drive pulse width T24. In the drive pulse width T24, the potential of the pump drive signal 668a becomes 72 V, and the potential of the pump drive signal 668b becomes 0 V. Therefore, the potential difference between the potential of the second electrode 274 and the potential of the first electrode 272 becomes -72 V. After a predetermined time period T22 has elapsed since the potential of the pump control signal 665b transitions from 0 V to 3.3 V, the potential of the pump control signal 665a transitions from 0 V to 3.3 V again over the predetermined time period T21. That is, the control in which the period T12 and the period T22 form one cycle is repeatedly performed. In the present embodiment, it is assumed that the center set value of the drive pulse widths T11 + T12 is 50 ms, and the driving frequency is 20 Hz. In addition, it is assumed that the center set value of the drive pulse widths T23 and T24 is 12.5 ms.

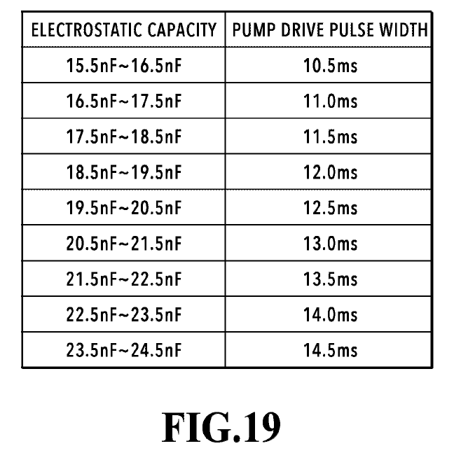

FIG. 19 is a table illustrating the correspondence relationship between the electrostatic capacity of the piezoelectric element provided in the circulation pump and the pump drive pulse width in the sixth embodiment. In the present embodiment, it is assumed that not only information 669 of the electrostatic capacity of the piezoelectric element 273 of the circulation pump 27, but also the contents of the table illustrated in FIG. 19 are written in the EEPROM 427.

Specifically, based on information 669 of the electrostatic capacity of the piezoelectric element 273 read out from the EEPROM 427, the CPU 400 refers to the table in FIG. 19 to output the boost signal 666a so that the corresponding pump drive pulse width is achieved. More specifically, as the value of the electrostatic capacity of the piezoelectric element 273 is increased, the displacement speed of the piezoelectric element 273 at the time when the pump drive voltage 607 is applied is decreased. Therefore, it is preferable that as the value of the electrostatic capacity of the piezoelectric element 273 is increased, the boost signal 666a is output so that the pump drive pulse width is set to a larger width than the set center. On the other hand, as the value of the electrostatic capacity of the piezoelectric element 273 is decreased, the displacement speed of the piezoelectric element 273 at the time when the pump drive voltage 607 is applied is increased. Therefore, it is preferable that as the value of the electrostatic capacity of the piezoelectric element 273 is decreased, the boost signal 666a is output so that the pump drive pulse width is set to a smaller width than the set center. By performing the processing as described above, even if manufacturing variations occur in the electrostatic capacity of the piezoelectric element 273 of the circulation pump 27, variations in the liquid delivery ability of the circulation pump 27 can be suppressed. That is, the circulation pump 27 can be driven at a circulation flow rate required by the liquid discharge apparatus 50.

### Seventh Embodiment

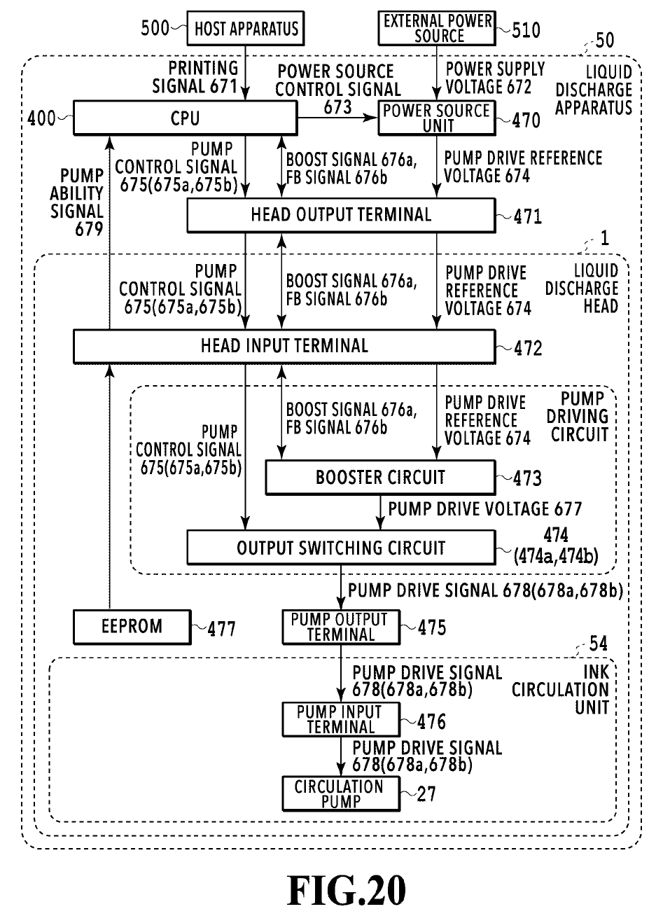

A seventh embodiment is different from the first to sixth embodiments in the arrangement location of an EEPROM 467. Hereinafter, the differences from the first to sixth embodiments will be mainly described. FIG. 20 is a diagram illustrating an example of the schematic configuration of the pump driving circuit that drives the circulation pump 27 in the seventh embodiment. The EEPROM 467 is arranged outside the ink circulation unit 54 and inside the liquid discharge head 1. The information 669 of the electrostatic capacity of the piezoelectric element 273 is written in the EEPROM 467. The CPU 400 reads out the information 669 of the electrostatic capacity of the piezoelectric element 273 from the EEPROM 467 via a head input terminal 472. As in the present embodiment, the EEPROM 467 storing the ability information that can be set by the components of the circulation pump 27, such as the information 669 of the electrostatic capacity of the piezoelectric element 273, may be arranged outside the ink circulation unit 54 and inside the liquid discharge head 1. Specifically, the EEPROM 467 may be mounted to the head board 210. With the arrangement as described above, the head board 210 can be shared. Therefore, the size of the liquid discharge head 1 can be reduced.

### Eighth Embodiment

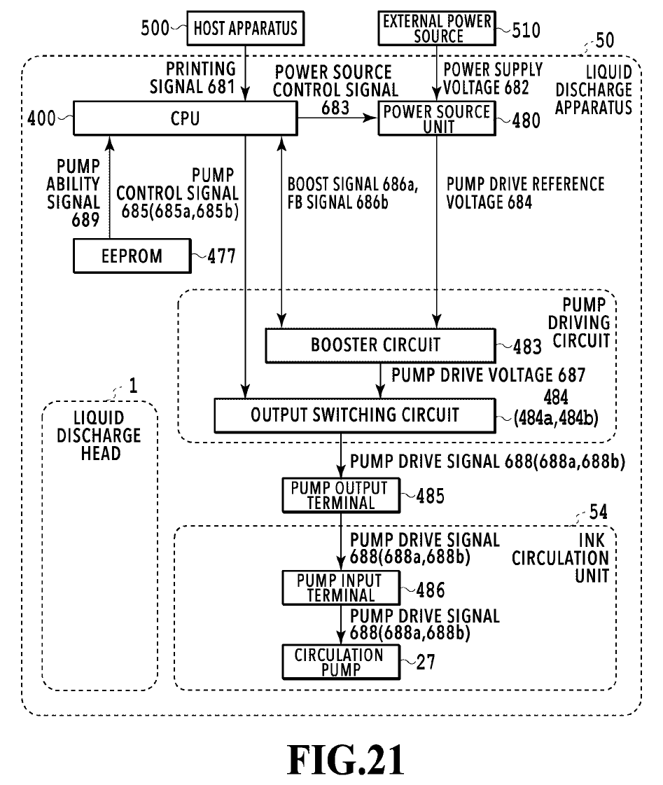

An eighth embodiment is different from the first to seventh embodiments in that the EEPROM 467 is arranged on the body side of the liquid discharge apparatus 50. Hereinafter, the differences from the first to seventh embodiments will be mainly described. FIG. 21 is a diagram illustrating an example of the schematic configuration of the pump driving circuit that drives the circulation pump 27 in the eighth embodiment. The EEPROM 467 is arranged outside the liquid discharge head 1 and on the body side of the liquid discharge apparatus 50. The information 669 of the electrostatic capacity of the piezoelectric element 273 is written in the EEPROM 467. The CPU 400 reads out the information 669 of the electrostatic capacity of the piezoelectric element 273 from the EEPROM 467. As in the present embodiment, the EEPROM 467 storing the ability information that can be set by the components of the circulation pump 27, such as the information 669 of the electrostatic capacity of the piezoelectric element 273, may be arranged outside the liquid discharge head 1 and on the body side of the liquid discharge apparatus 50. With the arrangement as described above, in a mode in which the circulation pump 27 is provided separately from the liquid discharge head 1, the ability information that can be set by the components of the circulation pump 27 can be written to the EEPROM 467 after a step of incorporating the circulation pump 27 into the liquid discharge apparatus 50. Accordingly, the manufacturing management of the liquid discharge apparatus 50 becomes easier.

### Other Embodiments

Although various examples and embodiments of the present disclosure have been illustrated and described above, the spirit and scope of the present disclosure are not limited to specific descriptions herein. The present disclosure is not limited to the above-described embodiments, and various modifications may be made. In addition, the present disclosure allows appropriate combinations of a part of the above-described embodiments.

### MODIFICATION 1

For example, the example has been described in which the pump drive frequency or the pump drive voltage 607 of the circulation pump 27 is controlled based on the ability information of the circulation pump 27, the example is not particularly limited to this. For example, due to manufacturing variations in the driving circuit 40A in FIG. 2, the pump drive frequency of the circulation pump 27 may also vary. In this case, the driving of the circulation pump 27 may be controlled by the pump drive voltage 607 of the circulation pump 27. Alternatively, due to manufacturing variations in the driving circuit 40A in FIG. 2, the pump drive voltage 607 of the circulation pump 27 may also vary. In this case, the driving of the circulation pump 27 may be controlled by the pump drive frequency of the circulation pump 27.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

According to the present disclosure, the circulation flow late of liquid can be appropriately controlled as needed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023460, filed February 17, 2025, which is hereby incorporated by reference herein in its entirety.

What is claimed is:

1. A liquid discharge head comprising:
a circulation channel capable of having liquid be circulate;
a discharge unit configured to discharge liquid circulating through the circulation channel;
a circulation pump configured to have liquid circulate through the circulation channel;
a pump drive unit configured to drive the circulation pump in accordance with ability information being able to be set by a component of the circulation pump;
a head board configured to implement a function of the pump driver unit; and
a storing unit configured to be mounted on the head board and configured to store the ability information, wherein
the ability information is an indicator of ability to have liquid circulate through the circulation channel.

2. The liquid discharge head according to claim 1, wherein the circulation pump includes a piezoelectric element configured to vibrate by a voltage to be applied, and generates a circulatory flow of liquid circulating through the circulation channel by utilizing vibration of the piezoelectric element, and
the pump drive unit utilizes an electrostatic capacity of the piezoelectric element as the ability information.

3. The liquid discharge head according to claim 2, wherein the pump drive unit controls a drive frequency of the circulation pump in accordance with the electrostatic capacity of the piezoelectric element.

4. The liquid discharge head according to claim 3, wherein in case where the electrostatic capacity of the piezoelectric element is a second electrostatic capacity larger than a first electrostatic capacity, the pump drive unit increases the drive frequency of the circulation pump in a case of the second electrostatic capacity compared to the drive frequency of the circulation pump in a case of the first electrostatic capacity.

5. The liquid discharge head according to claim 1, wherein the circulation pump further includes a vibrating plate configured to vibrate in accordance with applying a voltage, and moves the vibrating plate to generate a circulatory flow of liquid, and
the pump drive unit utilizes a thickness of the vibrating plate as the ability information.

6. The liquid discharge head according to claim 5, wherein the pump drive unit controls a drive frequency of the circulation pump in accordance with the thickness of the vibrating plate.

7. The liquid discharge head according to claim 6, wherein in case where the thickness of the vibrating plate is a second vibrating plate thickness larger than a first vibrating plate thickness, the pump drive unit increases the drive frequency of the circulation pump in a case of the second vibrating plate thickness compared to the drive frequency of the circulation pump in a case of the first vibrating plate thickness.

8. The liquid discharge head according to claim 1, wherein the circulation pump further includes a diaphragm unit configured to control inflow and outflow of liquid circulating through the circulation channel with respect to the circulation channel,
the diaphragm unit includes:
a pressure chamber configured to generate pressure fluctuation to generate a circulatory flow of liquid circulating through the circulation channel;
an inflow side valve element configured to control inflow of liquid circulating through the circulation channel from the circulation channel to the pressure chamber; and
an outflow side valve element configured to control outflow of liquid circulating through the circulation channel from the pressure chamber to the circulation channel, and
the pump drive unit configured to utilize a thickness of each of the inflow side valve element and the outflow side valve element as the ability information.

9. The liquid discharge head according to claim 8, wherein in case where the thickness of the inflow side valve element is a second valve thickness larger than a first valve thickness, the pump drive unit increases the drive frequency of the circulation pump in a case of the second valve thickness compared to the drive frequency of the circulation pump in a case of the first valve thickness.

10. The liquid discharge head according to claim 8, wherein in case where the thickness of the outflow side valve element is a second valve thickness larger than a first valve thickness, the pump drive unit increases the drive frequency of the circulation pump in a case of the second valve thickness compared to the drive frequency of the circulation pump in a case of the first valve thickness.

11. The liquid discharge head according to claim 2, wherein the circulation pump includes:
the piezoelectric element;
a vibrating plate arranged to overlap the piezoelectric element; and
a diaphragm unit configured to control inflow and outflow of liquid circulating through the circulation channel with respect to the circulation channel,
the diaphragm unit includes:
a pressure chamber arranged in close contact with the vibrating plate;
an inflow side valve element configured to control inflow of liquid circulating through the circulation channel from the circulation channel to the pressure chamber; and
an outflow side valve element configured to control outflow of liquid circulating through the circulation channel from the pressure chamber to the circulation channel, and
the pump drive unit configured to utilize, as the ability information, a combination of the electrostatic capacity of the piezoelectric element, a thickness of the vibrating plate, and a thickness of each of the inflow side valve element and the outflow side valve element.

12. The liquid discharge head according to claim 2, wherein the pump drive unit controls a drive voltage of the circulation pump in accordance with the electrostatic capacity of the piezoelectric element.

13. The liquid discharge head according to claim 2, wherein the pump drive unit controls a drive pulse width of the circulation pump in accordance with the electrostatic capacity of the piezoelectric element.

14. The liquid discharge head according to claim 1, further comprising:
a storing unit configured to be mounted to the head board and configured to store the ability information.

15. The liquid discharge head according to claim 1, further comprising:
a storing unit configured to store the ability information, wherein
the storing unit configured to be mounted to a body side of liquid discharge apparatus accommodating the liquid discharge head.

16. A liquid discharge apparatus comprising:
a circulation channel capable of having liquid be circulate;
a discharge unit configured to discharge liquid circulating through the circulation channel;
a circulation pump configured to have liquid circulate through the circulation channel; and
a pump drive unit configured to drive the circulation pump in accordance with ability information being able to be set by a component of the circulation pump, wherein
the ability information is an indicator of ability to have liquid circulate through the circulation channel.
